(19) United States
(12) Patent Application Publication
(10) Pub. No.: US 2025/0120399 A1
(43) Pub. Date: Apr. 17, 2025

(54) METHODS AND COMPOSITIONS FOR ALTERING METABOLITES IN VITIS SPP. AND PREVENTING PESTS AND PATHOGENS

(71) Applicant: Impello Biosciences, Inc., Fort Collins, CO (US)

(72) Inventor: Michael C. KEY, Fort Collins, CO (US)

(21) Appl. No.: 18/834,395

(22) PCT Filed: Feb. 2, 2023
(86) PCT No.: PCT/US2023/061881

§ 371 Date: Jul. 30, 2024

Related U.S. Application Data
(60) Provisional application No. 63/306,016, filed on Feb. 2, 2022.

(51) Int. Cl. A01N 37/42; A01P 3/00; A01P 21/00

(52) U.S. Cl. CPC A01N 37/42; A01P 3/00; A01P 21/00

(57) ABSTRACT

The disclosure relates to methods and compositions for altering the production of one or more plant metabolites in Vitis spp. comprising applying an effective amount of at least one elicitor, wherein the elicitor is a jasmonate or a salicylate, and combinations thereof. The disclosure further relates to methods and compositions for plant pest and pathogen control in Vitis spp. comprising applying an effective amount of at least one elicitor, wherein the elicitor is a jasmonate or a salicylate, and combinations thereof. The disclosure further teaches compositions comprising effective amounts of the elicitors disclosed here.

### CROSS-REFERENCE TO RELATED APPLICATIONS

This application claims the benefit of U.S. Patent Application No. 63/306,016, filed Feb. 2, 2022, entitled “Methods and Compositions for Altering Metabolites in Vitis spp.,” the disclosure of which is hereby incorporated by reference in its entirety.

### FIELD

The disclosure relates to biochemical compounds for improving plant productivity and/or harvestable crop value and methods of application.

### BACKGROUND

Over 6.9 million hectares of land worldwide are devoted to cultivated grapes. In 2017, 74.3 million metric tons of grapes were produced (Food and Agriculture Organization of the United Nations, available on the worldwide web at fao.org). Much of what is harvested is used to produce wine. Combined with other grape products, such as raisins, grape juice, jelly, grape seed oil, etc., the economic potential of grapes surpasses that of apples and oranges. The state of California is the fourth largest wine producer in the world, with 3,900 wineries and 5,900 grape growers, which produced a wine retail value of $43.6 billion in 2019 (wineinstitute.org, available on the worldwide web).

Much advancement has been made with respect to plant genetics. Grape varieties are being improved by using molecular markers for desirable traits, and transformation and genetic engineering for disease tolerance. However, these methods take time. It can take 20 years to develop a new grape cultivar by traditional breeding techniques, and once planted, three years or more to produce a crop of grapes. Thus, there remains a need for compositions and methods to improve the qualities of existing grape cultivars.

### BRIEF SUMMARY

The disclosure teaches a method for altering the production of one or more metabolites in a Vitis spp. plant, plant part, or plant cell, comprising: applying an effective amount of at least one elicitor, wherein the at least one elicitor is a jasmonate selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.

The disclosure further teaches a method of altering metabolite levels in a Vitis spp. plant, plant part, or plant cell, said method comprising: applying an effective amount of methyl dihydrojasmonate to a Vitis spp. plant or plant part.

The disclosure further teaches a method for increasing the flavonoid content in a Vitis spp. plant, plant part, or plant cell, the method comprising: applying an effective amount of methyl dihydrojasmonate, wherein said effective amount is comprised of a composition having between 1 mM and 10 mM methyl dihydrojasmonate applied at an application rate of between 50-100 gallons per acre.

The disclosure further provides a composition comprising methyl dihydrojasmonate and plant tissue from a Vitis spp. plant.

The disclosure further teaches a method for increasing total anthocyanins in a Vitis spp. fruit comprising: applying a composition comprising between 1 mM and 10 mM methyl dihydrojasmonate to a Vitis spp. plant, plant part, or plant cell, wherein the application of the composition increases total anthocyanins in Vitis spp. fruit compared to untreated controls.

The disclosure further teaches a method for increasing Brix in a Vitis vinifera fruit, comprising: applying a composition comprising between 1 mM and 10 mM methyl dihydrojasmonate to a Vitis vinifera plant, plant part, or plant cell, wherein the application of the composition increases Brix in Vitis vinifera fruit compared to untreated controls.

The disclosure further teaches a method for treating or preventing a Vitis spp. pest or plant pathogen, the method comprising: applying a composition having between 1 mM and 10 mM methyl dihydrojasmonate to a plant, plant part, or plant cell, wherein application of the composition reduces the percent severity and/or percent incidence of a pest or pathogen compared to untreated plants.

### DESCRIPTION OF THE DRAWINGS

The accompanying figures, which are incorporated herein and form a part of the specification, illustrate some, but not the only or exclusive, example embodiments and/or features. It is intended that the embodiments and figures disclosed herein are to be considered illustrative rather than limiting.

FIG. 1 is a bar graph showing the average BRIX levels in Malbec varieties treated with foliar applications of MDJ compared to control plants treated with a grower standard (GR STD).

FIG. 2 is a photograph of grape wine juice from control plants treated with a grower standard (left two glasses) and plants treated with MDJ (right three glasses).

FIG. 3 is a bar graph showing the percent incidence and the percent severity of Botrytis cinerea on wine grapes treated with applications of MDJ compared to plants treated with Serenade® Opi and untreated controls.

FIG. 4 is a bar graph showing the results of various treatments on hemp plants infected with Botrytis cinerea compared to an untreated control. Plants were scored on a scale of 0-5 and averaged, with 0 indicating no signs of infection.

### DETAILED DESCRIPTION OF THE INVENTION

All publications, patents and patent applications, including any drawings and appendices, are herein incorporated by reference to the same extent as if each individual publication or patent application was specifically and individually indicated to be incorporated by reference.

The following description includes information that may be useful in understanding the present disclosure. It is not an admission that any of the information provided herein is prior art or relevant to the presently claimed disclosures, or that any publication specifically or implicitly referenced is prior art.

### Definitions

As used herein, the term “about” refers to plus or minus 10% of the referenced number, unless otherwise stated or otherwise evident by the context (such as when a range would exceed 100% of a possible value or fall below 0% of a possible value). For example, reference to an absolute content of a particular cannabinoid of “about 1%” means that that cannabinoid can be present at any amount ranging from 0.9% to 1.1% content by weight. The term “about” also refers to plus or minus a day when referring to a length of time measured in days.

The term “a” or “an” refers to one or more of that entity; for example, “a gene” refers to one or more genes or at least one gene. As such, the terms “a” (or “an”), “one or more” and “at least one” are used interchangeably herein. In addition, reference to “an element” by the indefinite article “a” or “an” does not exclude the possibility that more than one of the elements is present, unless the context clearly requires that there is one and only one of the elements.

The International Code of Zoological Nomenclature defines rank, in the nomenclatural sense, as the level, for nomenclatural purposes, of a taxon in a taxonomic hierarchy (e.g., all families are for nomenclatural purposes at the same rank, which lies between superfamily and subfamily). While somewhat arbitrary, there are seven main ranks defined by the international nomenclature codes: kingdom, phylum/division, class, order, family, genus, and species.

As used herein, the term “elicitor” refers to any molecule that stimulates a response in a plant. Elicitors may be exogenous or endogenous, and may for example, activate the production of a secondary metabolite.

As used herein, the term “jasmonate or jasomates” refers to a class of compounds modulating plant responses to abiotic and biotic stimuli. The compounds may be produced endogenously in a plant, exogenously applied to a plant, or of synthetic origin, and include for example, methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof.

As used herein, “plant beneficial microbe(s)” refers to microorganisms that create symbiotic associations with plant roots, promote nutrient mineralization and availability, produce plant growth hormones, and are antagonists of plant pests, parasites or diseases.

As used herein, a “biostimulant” refers to a substance or micro-organism that, when applied to seeds, plants, or the rhizosphere, stimulates natural processes within the plant or the plant microbiome (including the entirety of the phytomicrombiome, e.g. the phyllosphere and rhizosphere) to enhance or benefit nutrient uptake, nutrient efficiency, tolerance to abiotic stress, or crop quality and yield.

As used herein, a “biological” or “agricultural biological” refers to a category of products derived from naturally occurring microorganisms, plant extracts, or other organic matter. In some embodiments, the biological is created from and/or contains living organisms, beneficial insects, plant extracts, or other organic matter.

As used herein, “altering” or “altered” may refer to an increase or decrease relative to a control value.

As used herein, “Brix”, or degrees Brix (°Bx) refers to the percentage of soluble solids, such as sugars and amino acids, by weight in a liquid.

As used herein, “veraison” refers to the stage where the plant transitions from berry growth to berry ripening.

As used herein, “altering” or “altered” may refer to an increase or decrease relative to a control value.

### Overview

The disclosure relates to methods and compositions for altering the production of one or more plant metabolites in Vitis spp. comprising applying an effective amount of at least one elicitor, wherein the elicitor is a jasmonate or a salicylate, and combinations thereof. The disclosure further relates to methods and compositions for plant pest and pathogen control in Vitis spp. comprising applying an effective amount of at least one elicitor, wherein the elicitor is a jasmonate or a salicylate, and combinations thereof. The disclosure further teaches compositions comprising effective amounts of the elicitors disclosed here.

### Grapevine

Grapevines (Vitis spp.) are a fruit bearing woody vines. The grapevine plant is popular for its fruits which grow in clusters of 15 to 300 grapes and can be found in a wide array of colors ranging from crimson black, dark blue, yellow, green, orange, and pink. The fruit of the plant can be eaten raw, but is also commonly used for making wine, jam, juice, jelly, grape seed extracts, raisins, vinegar, and grape seed oil. The grapevine plant is known as one of the earliest domesticated plant species, dating back over 6,000 years. Together with yeast, grapes are mainly known for their use in wine making. Ancient Egyptian hieroglyphics record the cultivation of purple grapes the history of the ancient Greeks and Phoenicians is riddled with references to grape cultivation.

According to the Food and Agriculture Organization (FAO), grapevines account for about 18,746,900 acres of arable land, with approximately 71% of the world's grape production being used for the production of wine. The world grape production for 2012 was estimated at 67,067,128 metric tons. Top producers of grapes include China, the U.S. Italy, France, and Spain.

In addition to the traditional taxonomic groupings of Vitis species, grapevine can also be categorized based on its intended use. Example categories of intended use include for example, wine grapes, juice grapes, raisin grapes and table grapes.

Wine grapes are less suitable for consumption as fresh fruit due to their many seeds chewy skins. They are smaller than table grapes, but have high levels of sugar. The skins will usually slip off if pressure is applied to the fruit. They are grown on trellises that maximize fruit exposure of the fruit. The nine noble red varieties are Cabernet Sauvignon, Pinot Noir, Merlot, Syrah, Grenache, Sangiovese, Nebbiolo, Tempranillo, and Malbec. The nine noble white varieties include Chardonnay, Sauvignon Blanc, Riesling, Pinot Gris/Grigio, Chenin Blanc, Gewürztraminer, Viognier, Semillon, and Moscato. Wine grapes are hardy in U.S. Department of Agriculture plant hardiness zones 5 through 9.

Table Grapes are grown differently than wine grapes. The trellises are designed so that grapes hang down in the shady center and are prevented from rubbing on other grape bunches or on stems and leaves. Table grapes are larger than wine grapes, and have less acidity and less sugar than wine grapes. They are intended to be eaten fresh, with skins that do not slip off. They may or may not include seeds. Example table grape varieties include the black “Concord” (Vitis “Concord”), the white “Thompson Seedless” (Vitis “Thompson Seedless”) and the red “Flame” (Vitis “Flame”). Table grapes are hardy in USDA zone 8 through 11.

Though nearly 4,000 different grape (Vitis spp.) varieties are spread around the world, most food products are from fewer than 40 species and varieties. Example species of grapevine include V. labrusca, V. riparia, V. rotundifolia, V. rupestris, V. aestivalis, V. mustangensis, and V. vinifera.

### Elicitors

Certain biochemicals are known to function endogenously within the plant and play roles within plant hormone signal transduction. Jasmonic Acid (JA) and Salicylic Acid (SA), which correspond to the Jasmonic Acid pathway and Salicylic Acid pathway in higher plants are responsible for modulating plant responses to abiotic and biotic stimuli. These biosynthetic pathways derive from alpha-linolenic acid metabolism and phenylalanine metabolism, respectively, and in some plant species are antagonists of each other; when JA pathways are upregulated, SA pathways are repressed, and vice versa. This phenomenon can be described in one sense by the chemical's relationship to the octadecanoid pathway, which is responsible for the production of jasmonic acid. Salicylates demonstrate negative crosstalk with jasmonates and likewise are considered inhibitors of the octadecanoid pathway.

Jasmonic acid is one of several endogenous lipid-based octadecanoid derivatives that are known to act as elicitors of plant defense, along with its methyl ester (methyl jasmonate, MeJA) and other derivatives (Saniewski M. (1997) The Role of Jasmonates in Ethylene Biosynthesis. In: Kanellis A. K., Chang C., Kende H., Grierson D. (eds) Biology and Biotechnology of the Plant Hormone Ethylene. NATO ASI Series (3. High Technology), vol 34). Jasmonates generally follow the same fundamental biosynthetic steps in plants, starting with the oxygenation of alpha-linolenic acid by lipoxygenase (13-LOX), which cyclizes to form allene oxide and then rearranges to form 12-oxophytodienoic acid (12-OPDA), which is then transformed into 7-iso-jasmonic acid via R-oxidations and can isomerize into JA. JA can then decarboxylate into the bioactive cis-jasmone (CJ), conjugate with isoleucine to produce JA-11e, or be metabolized into Methyl Jasmonate (MeJA), among others (Matsui, R., et al. Elucidation of the biosynthetic pathway of cis-jasmone in Lasiodiplodia theobromae. Sci Rep 7, 6688 (2017)).

Jasmonate derivatives, or derivatives of the octadecanoid pathway comprised of a cyclopentanone ring, cyclopentene ring, or other ketone may include an alkane chain or an alkene chain, or may include a different hydrocarbon chain and may include a carboxylic acid side chain of different lengths.

Shown below is the structure for Methyl Jasmonate (MeJA) (from National Center for Biotechnology Information (2021), PubChem Compound Summary for CID 5281929, Methyl jasmonate).

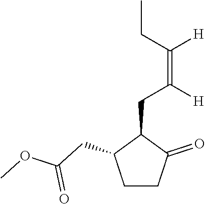 [SMILES: CC/C=C\C[C@H]1C(=O)CC[C@@H]1CC(=O)OC]

Shown below is the structure for methyl dihydrojasmonate (MDJ) (National Center for Biotechnology Information (2021). PubChem Compound Summary for CID 102861, Methyl dihydrojasmonate).

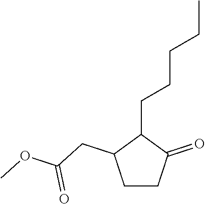 [SMILES: CCCCCC1C(=O)CCC1CC(=O)OC]

Shown below is the structure for cis-jasmone (CJ) (National Center for Biotechnology Information (2021). PubChem Compound Summary for CID 1549018, Jasmone).

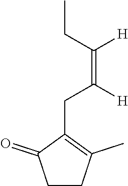

All jasmonates and even jasmonate-like molecules, including (+)-cucurbic acid and tuberonic acid, share some similarities in their chemical structures, such as cyclopentanone rings. However specific jasmonate-type responses in plants may be structure dependent and based on the presence of hydroxyl groups, methyl groups, hydrocarbon chains, carboxylic acid chains, or other functional groups, or may be dependent on the chirality of each jasmonate type compound, or may be dependent on the compound's stereoisomerism, or may be dependent on the compound's spatial isomerism, or otherwise dependent on the structure.

Prohydrojasmone (PDJ) is a synthetic derivative of jasmonic acid previously shown to increase anthocyanain and bring about the red color in apples (BLUSH™). Methyl dihydrojasmonate is only produced endogenously in a few plants, thus its ability to function as an elicitor was previously unresearched. Additionally, jasmonate derivatives like cis-jasmone (CJ) may be used to elicit more specific responses when applied exogenously in planta in comparison to the standard jasmonate elicitors like JA and MeJA.

### Methods of Altering the Production of a Plant Metabolite

In some embodiments, the present disclosure teaches a method for altering the production of one or more plant metabolites in a plant, plant part, or plant cell, comprising: applying an effective amount of at least one elicitor to the plant, plant part, or plant cell, wherein the at least one elicitor is a jasmonate.

In some aspects, the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof. In some embodiments, the jasmonate is a synthetic. In some aspects, the jasmonate is methyl jasmonate. In some aspects, the jasmonate is methyl dihydrojasmonate. In some aspects, the jasmonate is cis-jasmone.

In some aspects, the method comprises applying an effective amount of a composition comprising two or more jasmonates. In some aspects, the method comprises applying an effective amount of a composition comprising three jasmonates.

In some aspects, the method further comprises applying a non-jasmonate elicitor. In some aspects, the non-jasmonate elicitor is a salicylate. In some aspects, the salicylate is methyl salicylate and/or salicylic acid.

In some embodiments, the present disclosure teaches a method for altering the production of one or more plant metabolites in a plant, plant part, or plant cell, comprising applying an effective amount of a salicylate to the plant, plant part, or plant cell. In some aspects, the salicylate is methyl salicylate and/or salicylic acid. In some aspects, the method further comprises applying a jasmonate, wherein the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof.

### Compositions Comprising Jasmonate Elicitors

In some embodiments, present disclosure teaches compositions comprising at least one jasmonate and a surfactant, wherein the at least jasomonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof. In some aspects, the composition comprises methyl dihydrojasmonate. In some aspects, the composition comprises cis-jasmone.

In some aspects, the compositions comprise two jasmonates. In some aspects, the two jasmonates are methyl jasmonate and methyl dihydrojasmonate. In some aspects, the two jasmonates are methyl jasmonate and cis-jasmone. In some aspects, the two jasmonates are methyl dihydrojasmonate and cis-jasmone. In some aspects, the composition comprises three jasmonates. In some aspects, the three jasmonates are methyl jasmonate, methyl dihydrojasmonate, and cis-jasmone In some embodiments, the disclosure relates to a composition comprising methyl dihydrojasmonate and plant tissue and/or plant cells from a Vitis spp. plant.

By the term “surfactant” it is understood that wetting agents, surface-active agents or surfactants, dispersing agents, suspending agents, emulsifying agents, and combinations thereof, are included therein. Ionic and non-ionic surface-active agents can be used.

Examples of non-ionic surface-active agents include, but are not limited to, alkoxylates, N-substituted fatty acid amides, amine oxides, esters, sugar-based surfactants, polymeric surfactants, and mixtures thereof, allinol, nonoxynol, octoxynol, oxycastrol, oxysorbic (for example, polyoxyethylated sorbitol fatty-acid esters, thalestol, and polyethylene glycol octylphenol ether (TRITON®). In some embodiments, the surfactant is polysorbate-20.

Examples of ionic surfactants for use with the compositions described herein may include anionic surfac-tants such as alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sul-fonates, sulfonates of fatty acids and oils, sulfonates of ethoxylated alkylphenols, sulfonates of alkoxylated arylphe-nols, sulfonates of condensed naphthalenes, sulfonates of dodecyl- and tridecylbenzenes, sulfonates of naphthalenes and alkylnaphthalenes, sulfosuccinates or sulfosuccina-mates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl car-boxylates, and carboxylated alcohol or alkylphenol ethoxy-lates.

Persons having skill in the art will be able to formulate the compositions of the present disclosure with appropriate surfactants to allow for plant applications. In some embodiments, the amount of surfactant used is the minimum amount required to get the compound into solution/emulsion, and will generally be 0.1% to 5% by weight.

In some embodiments, the compositions disclosed herein further comprise additives, auxiliaries, and/or excipients. Additional components may act to improve the stability of the composition, improve the homogeneity of the composition, improve the function of the composition in planta, or provide other qualities to the composition and/or to the methodology of the present disclosure. In some embodiments, the composition further comprises amino acids, minerals, salts, solvents, stabilizers, hormones, enzymes, vitamins, chitin, chitosan, carboxylic acids, carboxylic acid derivatives, linoleic acid and other fatty acids, volatile organic compounds (VOCs), microbial consortia or isolates, bioregulators, biostimulants, and other additives known in the art to elicit a biological, biochemical, physiological, and/or physiochemical response from the plant, or to stabilize the composition, or to elicit specific metabolite production in the plant.

The composition may include other active or inactive ingredients. In some embodiments, the composition includes at least one fungicide. Example fungicides include, but are not limited to, azoxystrobin, bifujunzhi, coumethoxystrobin, coumoxystrobin; dimoxystrobin, enes-troburin, enoxastrobin, fenaminstrobin, fenoxystrobin, flufenoxystrobin, fluoxastrobin, jiaxiangjunzhi, kresoxim-methyl, mandestrobin, metominostrobin, orysastrobin, picoxystrobin, pyraclostrobin, pyrametostrobin, pyraox-ystrobin, triclopyricarb, trifloxystrobin, methyl 2-[2-(2,5-dimethylphenyloxymethy 1) pheny 1]-3-methoxyacry late, pyribencarb, triclopyricarb/chlorodincarb, famoxadon, fena-midon, cyazofamid, amisulbrom, benodanil, bixafon, boscalid, carboxin, fenfuram, fluopyram, flutolanil, fluxapy-roxad, furametpyr, isopyrazam, mepronil, oxycarboxin, pen-flufen, penthiopyrad, sedaxane, tecloftalam, thifluzamide, N-(4′-trifluoromethy lthio-bipheny 1-2-yl)-3-difluoromethy 1-1-methy 1-1H-pyrazole-4-carboxamide, N-(2-(1,3,3-trimeth-ylbutyl)phenyl)-1,3-dimethyl-5-fluoro-1H-pyrazole-4-car-boxamide, N-[9-(dichloromethylene)-1,2,3,4-tetrahydro-1,4-methanonaphthalen-5-yl]-3-(difluoromethyl)-1-methyl-H-pyrazole-4-carboxamide, diflumetorim, binapacryl, dinobuton, dinocap, meptyl-dinocap, fluazinam, ferimzone, ametoctradin, silthiofam, azaconazole, bitertanol, bromuconazole, cyproconazole, difenoconazole, diniconazole, diniconazole-M, epoxiconazole; fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, imazalil, pefurazoate, prochloraz, triflumizole, pyrimidines, fenari-mol, nuarimol, pyrifenox, triforine, aldimorph, dodemorph, dodemorph acetate, fenpropimorph, tridemorph, fenpropidin, piperalin, spiroxamine, fenhexamid, benalaxyl, benal-axyl-M, kiralaxyl; metalaxyl, metalaxyl-M (mefenoxam), ofurace; oxadixyl, hymexazole, octhilinone, oxolinic acid, bupirimate, benomyl, carbendazim, fuberidazole, thiaben-dazole, thiophanate-methyl, 5-chloro-7-(4-methyl-piperi-din-1-yl)-6-(2,4,6-trifluorophenyl)-[1,2,4]triazolo[1,5-a]pyrimidine, diethofencarb, ethaboxam, pencycuron, fluopicolid, zoxainid, metrafenon, pyriofenon, cyprodinil, mepanipyrim, pyrimethanil, fluoroimide, iprodione, procymidone, vinclozolin fenpiclonil, fludioxonil, quinoxyfen, edifenphos, iprobenfos, pyrazophos, isoprothiolane, dicloran, quintozene, tecnazene, tolclofos-methyl, biphenyl, chloroneb, etridiazole, dimethomorph, flumorph, mandipropamid, pyrimorph, benthiavalicarb, iprovalicarb, valifenal-ate and 4-fluorophenyl N-(1-(1-(4-cyanophenyl) ethanesul-fonyl) but-2-yl) carbamate, propamocarb, propamocarb hydrochloride, ferbam, mancozeb, maneb, metiram, propineb, thiram, zineb, ziram, anilazine, chlorothalonil, captafol, captan, folpet, dichlofluanid, dichlorophen, flusulfamide, hexachlorobenzene, pentachlorophenol, phthalid, tolylfluanid, N-(4-chloro-2-nitrophenyl)-N-ethyl-4-methyl-benzenesulfonamide, guanidine, dithianon, validamycin, polyoxin B, pyroquilon, tricyclazole, carpropamid, dicyclomet, fenoxanil, and mixtures thereof.

In some embodiments, the composition comprises at least one growth regulator. In some aspects, the growth regulator an ethylene inhibitor. In some aspects, the growth regulator is 1-methylcyclopropene (1-MCP).

In some embodiments, the composition may be prepared as a concentrate for industrial application and further dilution or as a fully diluted ready-to-apply composition. In some aspects, the elicitor in a ready-to-apply composition is between 1 mM and 10 mM. In some aspects, the elicitor in a ready-to-apply composition is 1 mM, 2 mM, 3 mM, 4 mM, 5 mM, 6 mM, 7 mM, 8 mM, 9 mM or 10 mM. In some aspects, the elicitor in a ready-to-apply composition is between about 1-2 mM, between about 2-3 mM, between about 3-4 mM, between about 4-5 mM, between about 5-6 mM, between about 6-7 mM, between about 7-8 mM, between about 8-9 mM, or between about 9-10 mM.

The compositions disclosed herein include liquid and/or dry forms and include dry stock components that are added to water or other liquids prior to application to the plant in an aqueous form. Liquid compositions include aqueous, polar, or non-polar solutions. The compositions may comprise an oil-in-water emulsion or a water-in-oil emulsion. In some embodiments, the composition is diluted. In some embodiments the composition is concentrated. In some embodiments the composition is aqueous.

The effect on plants of the disclosed methods and compositions can be observed both genetically and chemically by any or all of the well-known analysis techniques including genomics, transcriptomics, proteomics, and metabolomics. The effect of different treatments on primary and secondary metabolite production can influence the taste, smell, appearance, effect, quality, yield, stress tolerance, and/or productivity of the living plant and its harvestable plant parts.

In some embodiments, the compositions disclosed herein may be mixed with one or more auxiliaries, adjuvants, excipients, surfactants, or other chemicals. Jasmonates and salicylates may be applied simultaneously but separately from plant growth inputs, like nutrients and pesticides, for improved performance or facility. In some embodiments, jasmonate compounds including but not limited to MeJA, MDJ, and CJ are used independently or as a mixture and applied in conjunction with antagonistic compounds including, but not limited to salicylates, like Methyl Salicylate (MS) and SA. A jasmonate may be applied at the same time, or at a different time than the antagonistic compound, in order to elicit distinct metabolomic responses from the plant.

### Biologicals

In some embodiments, the disclosure provides for compositions and methods of using both biological (e.g., microbial) and biochemical (jasmonate) applications targeted toward pests and pathogens. In some embodiments, the jasmonate or composition comprising a jasmonate is applied in combination with one or more biologicals.

Biologicals are products that are created from, or derived from, living organisms, plant extracts, beneficial insects, or other organic matter. Additional names in the art include, for example, bioeffector, biocontrol agent, bioherbicide, bioactivity, biorational insecticide, and biodigester.

In recent years they have become a valuable tool in sustainable agriculture. Induced Systemic Resistance (ISR) is a phenomenon characterized by soil-inhabiting rhizobacteria repressing soil-borne, necrotrophic pathogens. ISR is the emergence of plant-wide pest resistance triggered from an abiotic stress, such as plant interaction with a biological. Thus in some embodiments, contacting a biological to a plant may cause the plant to develop resistance to one or more pests. In some embodiments, the biological itself also exhibits pest control properties. Numerous pathogens are also susceptible to jasmonate-mediated defense (Glazebrook, J. Contrasting Mechanisms of Defense Against Biotrophic and Necrotrophic Pathogens, Ann. Rev. of Phytopathology (2005) 43:205-227). Therefore, in some embodiments, by reinforcing jasmonate mediated defenses through ISR elicitation, biologicals comprising beneficial bacteria enhance biocontrol.

In some embodiments, a biological comprised by a composition herein, or employed in a method herein, comprises a biostimulant, a biopesticide, or a biofertilizer. In some embodiments, a biological herein is a composition comprising microbes. In some embodiments, a biological herein comprises a rhizobacterium. In some embodiments, the biological comprises a Bacillus sp. In some embodiments, the biological comprises Azospirillum sp. In some embodiments, the biological comprises Pantoea sp. In some embodiments, a biological herein comprises an Agrobiotech product from Probelte®. In some embodiments, a biological herein comprises a product from Impello®.

In some embodiments, a biological herein is a composition comprising microbes. In some embodiments, a biological herein is a product listed in Table 1. In some embodiments, a biological herein comprises a bacterial strain listed in Table 1.

TABLE 1
Illustrative biological products and bacterial strains.

| Product | Strains |
|---|---|
| Impello ® Tribus ® | Bacillus subtilis strain Itri1 |
| | Bacillus pumilus strain Itri2 |
| | Bacillus amyloliquefaciens strain Itri3 |
| Impello ® Continuum ™ | Paenibacillus chitinolyticus strain Icon1, |
| | Bacillus subtilis strain Icon2 |
| | Bacillus pumilus strain Icon3 |
| | Bacillus amyloliquefaciens strain Icon4 |
| Probelte ® Biopron ™ or | Azospirillum brasilense strain Pbio1 |
| Biopron ™ Premium | Pantoea dispersa strain Pbio2 |
| Probelte ® Bøtrybël ™ | Bacillus amyloliquefaciens strain Pbot1 |
| Probelte ® Bulhnova ™ | Azospirillum brasilense strain Pbul1 |
| | Pantoea dispersa strain Pbul2 |
| Probelte ® Nemapron ™ | Azospirillum sp. strain Pnem1 |
| | Bacillus spp. strain Pnem2 |
| Probelte ® Strongest ™ | Azospirillum brasilense strain Pstr1 |
| Probelte ® Belthirul ™ | Bacillus thuringiensis var. kurstaki strain Pbel1 |
| Probelte ® Belthirul ™ F | Bacillus thuringiensis var. kurstaki strain Pbel1F |
| Probelte ® Belthirul ™ S | Bacillus thuringiensis var. kurstaki strain Pbel1S |
| Probelte ® Belthirul ™ 16 SC | Bacillus thuringiensis var. kurstaki strain Pbel116SC |
| Probelte ® Lepiback ™ | Bacillus thuringiensis var. kurstaki strain Plep1 |

In some embodiments, a biological herein comprises any of the species or strains listed in Table 1. In some embodiments, the biological comprises about 10⁴, 10⁵, 10⁶, 10⁷, 10⁸, 10⁹, or 10¹⁰ CFU/mL of a microbe listed herein. In some embodiments, the biological comprises about 10⁷, 10⁸, 10⁹, or 10¹⁰ CFU/g of a microbe listed herein.

### Biostimulants

In some embodiments, the biological comprises a biostimulant. Biostimulants are substances or microorganisms that, when applied to seeds, plants, or the rhizosphere, stimulate natural processes within the plant or the plant microbiome (including the entirety of the phytomicrombiome, e.g. the phyllosphere and rhizosphere) to enhance or benefit nutrient uptake, nutrient efficiency, tolerance to abiotic stress, or crop quality and yield. In some embodiments, the biological is a biostimulant. In some embodiments, the biostimulant comprises humic substances, hormones, cell signaling molecules, seaweed extract, and/or amino acids.

In some embodiments, the biological is selected from auxins, cytokinins, gibberellins, abscisic acid, ethylene, brassinosteroids, jasmonic acid, strigolactones, chemical mimics of strigolactone, and combinations thereof.

In some embodiments, the biostimulant comprises a strigolactone or chemical mimics of strigolactone. Such compounds are described in PCT/US2016/029080, filed Apr. 23, 2016, and entitled: Methods for Hydraulic Enhancement of Crops, and US2021/0329917, published Oct. 28, 2021 and entitled: Compounds and Methods for Increasing Soil Nutrient Availability, which are hereby incorporated by reference. They are further described in U.S. Pat. No. 9,994,557, issued on Jun. 12, 2018, and entitled: Strigolactone Formulations and Uses Thereof, which is hereby incorporated by reference.

### Biopesticides

In some embodiments, the biological comprises a biopesticide. Biopesticides include any naturally occurring substance that controls pests, known as biochemical pesticides, microorganisms that control pests, known as microbial pesticides, and pesticidal substances produced by plants containing added genetic material-known as plant-incorporated protectants or PIPs. Biopesticides can also include semiochemicals, peptides, proteins and nucleic acids such as double-stranded DNA, single-stranded DNA, double-stranded RNA, single-stranded RNA and hairpin DNA or RNA. In some embodiments, the biological is a biopesticide disclosed in Table 2.

TABLE 2
Examples of Biopesticides

| Source | Type | Organism | Pest Type |
|---|---|---|---|
| Bacteria | Insecticide | Bacillus thuringiensis var | caterpillars, fungi |
| | | kurstaki | (Botrytis) Elm Leaf |
| | | B. thuringiensis var | Beetle, Alfalfa weevil |
| | | tenebrionis | |
| | Fungicide | Bacillus subtilis | Botrytis spp. |
| Fungi | Insecticide | Beauveria bassiana | Whitefly |
| | Fungicide | Coniothyrium minitans | Sclerotinia spp. |
| | | Trichoderma harzianum | S sclerotiorum |
| | Herbicide | Chondrostereum | cut stumps of hardwood |
| | | purpureum | trees and shrubs |
| | Nematicide | Paecilomyces lilacinus | plant-parasitic |
| | | | nematodes in soil |
| Virus | Insecticide | Cydia pomonella | codling moth |
| | | granulovirus | |
| Oomycetes | Herbicide | Phytophthora palmivora | Morenia orderata |
| Neem (Azadirachta | Insecticide | Azadirachtin | aphids, scale, thrips, |
| indica) | | | whitefly, leafhoppers, |
| | | | weevils |
| Plant extracts | Fungicide | Reynoutria sachalinensis | powdery mildew, |
| | | (giant knotweed) extract | downy mildew, Botrytis, |
| | | | late blight, citrus canker |
| | Herbicide | Plant essential oils | Ragwort, many |
| | | | arthropods |
| | Nematicide | Quillaja saponaria | plant parasitic |
| | | | nematodes |
| Talaromyces flavus; | Biopesticides | | Glomerella cingulata |
| Clitoria ternatea | | | and Colletotrichum |
| (butterfly pea); | | | acutatum; Helicoverpa |
| Trichoderma | | | spp.; Fusarium |
| harzianum; Bacillus | | | oxysporum Agelastica |
| thuringiensis var. | | | alni; Spodoptera litura, |
| tenebrionis; | | | Helicoverpa armigera, |
| Lactobacillus casei | | | Aphis gossypii; |
| fermentation | | | Xanthomonas fragariae; |
| products | | | Spodoptera littoralis |
| | | | and others |
| Semiochemical | Attractant | Citronellol | tetranychid mites |
| | | Multi-component sex | codling moth |
| | | pheromone, such as | |
| | | (E,E)-8,10-dodecadien- | |
| | | 1-ol | |
| Arbuscular | Filamentous | Nostoc piscinale; | |
| Mycorrhizal Fungi | cyanobacterium; | Chlamydopodium | |
| | Single-celled | fusiforme; Chlorella | |
| | green algae | vulgaris | |
| | | Anabaena laxa and | Increase in fungicidal |
| | | Calothrix elenkinii | activity |
| Nanobiopesticide | Silver | | Alternaria alternata, |
| | nanobiopesticide | | A. solani |
| | Sargassum | | Ariadne merione, a |
| | muticum derived | | Lepidopteran pest |
| | NPs | | |
| | Caulerpa | | Culex quinquefasciatus |
| | scalpelliformis | | |
| | and | | |
| | Mesocyclops | | |
| | longisetus- | | |
| | derived NPs | | |

In some embodiments, the biological is a biochemical pesticide. Biochemical pesticides control pests by non-toxic mechanisms, such as insect sex pheromones that interfere with mating, and plant extracts that attract an insect pest to a trap or repel an insect pest. Examples of plant extracts used as biochemical pesticides are neem and lemongrass oil. A biochemical pesticide may also be an insect growth regulator, and inhibit processes required for survival of the insect.

Plants produce a wide variety of secondary metabolites that deter herbivores from feeding on them. Some of these can be used as biopesticides. They include, for example, pyrethrins, which are fast-acting insecticidal compounds produced by Chrysanthemum cinerariaefolium. They have low mammalian toxicity but degrade rapidly after application. This short persistence prompted the development of synthetic pyrethrins (pyrethroids). The most widely used botanical compound is neem oil, an insecticidal chemical extracted from seeds of Azadirachta indica. Two highly active pesticides are available based on secondary metabolites synthesized by soil actinomycetes, but they have been evaluated by regulatory authorities as if they were synthetic chemical pesticides. Spinosad is a mixture of two macrolide compounds from Saccharopolyspora spinosa. It has a very low mammalian toxicity and residues degrade rapidly in the field. Farmers and growers used it widely following its introduction in 1997 but resistance has already developed in some important pests such as western flower thrips. Abamectin is a macrocyclic lactone compound produced by Streptomyces avermitilis. It is active against a range of pest species but resistance has developed to it also, for example, in tetranychid mites.

Peptides and proteins from a number of organisms have been found to possess pesticidal properties. Perhaps most prominent are peptides from spider venom (King, G. F. and Hardy, M. C. (2013) Spider-venom peptides: structure, pharmacology, and potential for control of insect pests. Annu. Rev. Entomol. 58:475-496). A unique arrangement of disulfide bonds in spider venom peptides render them extremely resistant to proteases. As a result, these peptides are highly stable in the insect gut and hemolymph and many of them are orally active. The peptides target a wide range of receptors and ion channels in the insect nervous system. Other examples of insecticidal peptides include: sea anemone venom that act on voltage-gated Na+ channels (Bosmans, F. and Tytgat, J. (2007) Sea anemone venom as a source of insecticidal peptides acting on voltage-gated Na+ channels. Toxicon. 49 (4): 550-560); the PA1b (Pea Albumin 1, subunit b) peptide from Legume seeds with lethal activity on several insect pests, such as mosquitoes, some aphids and cereal weevils (Eyraud, V. et al. (2013) Expression and Biological Activity of the Cystine Knot Bioinsecticide PA1b (Pea Albumin 1 Subunit b). PLOS ONE 8 (12): e81619); and an internal 10 kDa peptide generated by enzymatic hydrolysis of Canavalia ensiformis (jack bean) urease within susceptible insects (Martinelli, A. H. S., et al. (2014) Structure-function studies on jaburetox, a recombinant insecticidal peptide derived from jack bean (Canavalia ensiformis) urcase. Biochimica et Biophysica Acta 1840:935-944). Examples of commercially available peptide insecticides include Spear™-T for the treatment of thrips in vegetables and ornamentals in greenhouses, Spear™-P to control the Colorado Potato Beetle, and Spear™-C to protect crops from lepidopteran pests (Vestaron Corporation, Kalamazoo, MI). A novel insecticidal protein from Bacillus bombysepticus, called parasporal crystal toxin (PC), shows oral pathogenic activity and lethality towards silkworms and Cry1 Ac-resistant Helicoverpa armigera strains (Lin, P. et al. (2015) PC, a novel oral insecticidal toxin from Bacillus bombysepticus involved in host lethality via APN and BtR-175. Sci. Rep. 5:11101).

A semiochemical is a chemical signal produced by one organism that causes a behavioral change in an individual of the same or a different species. The most widely used semiochemicals for crop protection are insect sex pheromones, some of which can now be synthesized and are used for monitoring or pest control by mass trapping, lure-and-kill systems and mating disruption. Worldwide, mating disruption is used on over 660,000 ha and has been particularly useful in orchard crops.

In some embodiments, the biological is a microbial pesticide. Microbial pesticides comprise a microorganism as the active ingredient. The microorganism may be a bacterium, fungus, virus, or protozoan.

An example microbial pesticide are some species and strains of Bacillus thuringiensis (Bt), which can control for example, moths, flies, and mosquitoes. Other microbial pesticides may be obtained from species of Bacillus, Pseudomonas, Yersinia, Chromobacterium, Beauveria, Metarhizium, Verticillium, Lecanicillium, Hirsutella, Paecilomyces, baculoviruses, arbuscular mycorrhizal fungi, Heterorhabditis, and Steinernema. In some embodiments, the microbial pesticide is derived from Bacillus thuringiensis.

The most widely used microbial biopesticide is the insect pathogenic bacteria Bacillus thuringiensis (Bt), which produces a protein crystal (the Bt 8-endotoxin) during bacterial spore formation that is capable of causing lysis of gut cells when consumed by susceptible insects. Microbial Bt biopesticides consist of bacterial spores and 8-endotoxin crystals mass-produced in fermentation tanks and formulated as a sprayable product. Bt does not harm vertebrates and is safe to people, beneficial organisms and the environment. Thus, Bt sprays are a growing tactic for pest management on fruit and vegetable crops where their high level of selectivity and safety are considered desirable, and where resistance to synthetic chemical insecticides is a problem. Bt sprays have also been used on commodity crops such as maize, soybean and cotton, but with the advent of genetic modification of plants, farmers are increasingly growing Bt transgenic crop varieties.

Other microbial insecticides include products based on entomopathogenic baculoviruses. Baculoviruses that are pathogenic to arthropods belong to the virus family and possess large circular, covalently closed, and double-stranded DNA genomes that are packaged into nucleocapsids. More than 700 baculoviruses have been identified from insects of the orders Lepidoptera, Hymenoptera, and Diptera. Baculoviruses are usually highly specific to their host insects and thus, are safe to the environment, humans, other plants, and beneficial organisms. Over 50 baculovirus products have been used to control different insect pests worldwide. In the US and Europe, the Cydia pomonella granulovirus (CpGV) is used as an inundative biopesticide against codlingmoth on apples. Washington State, as the biggest apple producer in the US, uses CpGV on 13% of the apple crop. In Brazil, the nucleopolyhedrovirus of the soybean caterpillar Anticarsia gemmatalis was used on up to 4 million ha (approximately 35%) of the soybean crop in the mid-1990s. Viruses such as Gemstar® (Certis USA) are available to control larvae of Heliothis and Helicoverpa species.

At least 170 different biopesticide products based on entomopathogenic fungi have been developed for use against at least five insect and acarine orders in glasshouse crops, fruit and field vegetables as well as commodity crops. The majority of products are based on the ascomycetes Beauveria bassiana or Metarhizium anisopliae. M. anisopliae has also been developed for the control of locust and grasshopper pests in Africa and Australia and is recommended by the Food and Agriculture Organization of the United Nations (FAO) for locust management.

A number of microbial pesticides are registered in the United States. See for example Kabaluk et al. 2010 (Kabaluk, J. T. et al. (ed.). 2010. The Use and Regulation of Microbial Pesticides in Representative Jurisdictions Worldwide. IOBC Global. 99pp. Microbial pesticides registered in selected countries are listed in Annex 4 of Hoeschle-Zeledon et al. 2013 (Hoeschle-Zeledon, I., P. Neuenschwander and L. Kumar. (2013). Regulatory Challenges for biological control. SP-IPM Secretariat, International Institute of Tropical Agriculture (IITA), Ibadan, Nigeria. 43 pp.), each of which is incorporated herein in its entirety.

In some embodiments, the biological is a Plant-Incorporated-Protectant (PIP). PIPs are pesticidal substances produced by genetically engineered plants. For example, in some embodiments, a plant is engineered to produce one or more of the pesticidal Cry or VIP proteins from Bacillus thuringiensis.

As used herein, “transgenic insecticidal trait” refers to a trait exhibited by a plant that has been genetically engineered to express a nucleic acid or polypeptide that is detrimental to one or more pests. In one embodiment, the plants of the present disclosure are resistant to attachment and/or infestation from any one or more of the pests of the present disclosure. In one embodiment, the trait comprises the expression of vegetative insecticidal proteins (VIPs) from Bacillus thuringiensis, lectins and proteinase inhibitors from plants, terpenoids, cholesterol oxidases from Streptomyces spp., insect chitinases and fungal chitinolytic enzymes, bacterial insecticidal proteins and early recognition resistance genes. In another embodiment, the trait comprises the expression of a Bacillus thuringiensis protein that is toxic to a pest. In one embodiment, the Bt protein is a Cry protein (crystal protein). Bt crops include Bt corn, Bt cotton and Bt soy. Bt toxins can be from the Cry family (see, for example, Crickmore et al., 1998, Microbiol. Mol. Biol. Rev. 62:807-812), which are particularly effective against Lepidoptera, Coleoptera and Diptera.

Bt Cry and Cyt toxins belong to a class of bacterial toxins known as pore-forming toxins (PFT) that are secreted as water-soluble proteins undergoing conformational changes in order to insert into, or to translocate across, cell membranes of their host. There are two main groups of PFT: (i) the α-helical toxins, in which α-helix regions form the trans-membrane pore, and (ii) the β-barrel toxins, that insert into the membrane by forming a β-barrel composed of βsheet hairpins from each monomer. See, Parker M W, Feil S C, “Pore-forming protein toxins: from structure to function,” Prog. Biophys. Mol. Biol. 2005 May; 88 (1): 91-142. The first class of PFT includes toxins such as the colicins, exotoxin A, diphtheria toxin and also the Cry three-domain toxins. On the other hand, aerolysin, α-hemolysin, anthrax protective antigen, cholesterol-dependent toxins as the perfringolysin O and the Cyt toxins belong to the β-barrel toxins. Id. In general, PFT producing-bacteria secrete their toxins and these toxins interact with specific receptors located on the host cell surface. In most cases, PFT are activated by host proteases after receptor binding inducing the formation of an oligomeric structure that is insertion competent. Finally, membrane insertion is triggered, in most cases, by a decrease in pH that induces a molten globule state of the protein. Id.

The development of transgenic crops that produce Bt Cry proteins has allowed the substitution of chemical insecticides by environmentally friendly alternatives. In transgenic plants the Cry toxin is produced continuously, protecting the toxin from degradation and making it reachable to chewing and boring insects. Cry protein production in plants has been improved by engineering cry genes with a plant biased codon usage, by removal of putative splicing signal sequences and deletion of the carboxy-terminal region of the protoxin. See, Schuler T H, et al., “Insect-resistant transgenic plants,” Trends Biotechnol. 1998; 16:168-175. The use of insect resistant crops has diminished considerably the use of chemical pesticides in areas where these transgenic crops are planted. See, Qaim M, Zilberman D, “Yield effects of genetically modified crops in developing countries,” Science. 2003 Feb. 7; 299 (5608): 900-2.

In some embodiments, the plant is engineered to express a protein selected from δ-endotoxins including but not limited to: the Cry, Cry2, Cry3, Cry4, Cry5, Cry6, Cry7, Cry8, Cry9, Cry10, Cry11, Cry12, Cry13, Cry14, Cry15, Cry16, Cry17, Cry18, Cry19, Cry20, Cry21, Cry22, Cry23, Cry24, Cry25, Cry26, Cry27, Cry 28, Cry 29, Cry 30, Cry31, Cry32, Cry33, Cry34, Cry35, Cry36, Cry37, Cry38, Cry39, Cry40, Cry41, Cry42, Cry43, Cry44, Cry45, Cry 46, Cry47, Cry49, Cry 51, Cry52, Cry 53, Cry 54, Cry55, Cry56, Cry57, Cry58, Cry59. Cry60, Cry61, Cry62, Cry63, Cry64, Cry65, Cry66, Cry67, Cry68, Cry69, Cry70 and Cry71 classes of 8-endotoxin genes and the B. thuringiensis cytolytic cyt1 and cyt2 genes.

### Biofertilizers

In some embodiments, the biological comprises a biofertilizer Biofertilizers are microorganisms, such as bacteria, fungi, and algae, that provide plants with nutrients, or help them to absorb nutrients, thus improving plant yield. Types of biofertilizers include, but are not limited to, microbes that increase nitrogen fixation, microbes that increase phosphate solubilization, microbes that increase nutrient mobilization, plant growth-promoting microbes, and plant growth-regulating microbes.

In some embodiments, the biological is a biofertilizer selected from the group consisting of a bacterial, algal, and fungal biofertilizer. In some embodiments, the biological is a biofertilizer that comprises at least one of a nitrogen fixer, a phosphate solubilizer, a nutrient mobilizer, plant growth-promoting bacteria, and plant growth-regulating bacteria.

In some embodiments, the biological comprises one or more species of cultured microbe selected from Methylobacterium, mycorrhizal fungi, Gluconacetobacter, Achromobacter, Agrobacterium, Anabaena, Azorhizobium, Azospirillum, Azotobacter, Bacillus, Beauveria, Bradyrhizobium, Clostridium, Enterobacter, Klebsiella, Kluyvera, Kosakonia, Mesorhizobium, Microbacterium, Ochrobactrum, Pantoea, Penicillium, Pseudomonas, Rahnella, Rhizoctonia, Rhizobium, Rhodopseudomonas, Sinorhizobium, Trichoderma, and combinations thereof.

In some embodiments, the biological comprises plant growth-promoting fungi and/or plant growth-promoting bacteria.

### Plant Growth-Promoting Fungi (PGPF)

PGPF species are beneficial to plants in several ways. For example, they can solubilize and mineralize nutrients making them accessible to plants; they regulate hormones; they produce compounds that suppress plant pathogens and alleviate abiotic stressors. In some embodiments, the biological comprises PGPF species of the genera Aspergillus, Penicillium, Phoma, Fusarium, Trichoderma, Piriforma, and Glomus.

### Aspergillus

In some embodiments, the biological comprises an Aspergillus species. Species of the fungi Aspergillus can protect plants and promote plant growth via production of pytases, auxins, gibberellins, and many secondary metabolites. The phytases for example, aid in phosphate solubilization. Some species of Aspergillus also are antagonist to plant pathogens (see for example, Nayak S. et al., (2020). Beneficial Role of Aspergillus sp. in Agricultural Soil and Environment, Frontiers in Soil and Environmental Microbiology (pp. 17-36)). Species of Aspergillus that have plant beneficial activity that may be included with the compositions, methods, kits, and systems disclosed herein. In some embodiments, the biological comprises a species of Aspergillus selected from, but not limited to, A. aculeatus, A. brasiliensis, A. clavatus, A. flavus, A. fumigatus, A. mellus, A. niger, A. nidulans, A. oryzae, A. sydowii, A. terreus, A. tubingensis, A. ustus, and A. sp. versicolor.

### Penicillium

In some embodiments, the biological comprises a Penicillium species. Many species of Penicillium have positive interactions with plants and can promote plant growth by supplying soluble phosphorus, indole-3-acetic acid, and gibberellic acid, and can also provide protection by acting as an antagonist to pathogens and/or activating plant defense signaling, and tolerance to abiotic stressors related to temperature, heavy metals, salt, and water. In some embodiments, the biological comprises a species of Penicillium selected from, but not limited to, P. bilaiae. P. brevicompactum, P. brocae, P. canescens, P. cecidicola, P. citrinum, P. coffeae, P. commune, P. crustosum, P. funiculosum, P. janthinellum, P. monteilii, P. olsonii, P. oxalicum, P. radicum, P. ruqueforti, P. sclerotiorum, P. simplicissimum, and P. steckii.

### Trichoderma

In some embodiments, the biological comprises a Trichoderma species. Species of Trichoderma are present in soils all over the world. They have been shown to form mutualistic relationships with several plant species, regulating the rate of plant growth and suppressing the growth of plant pathogens through competition, antibiotic production, and chitinase secretion. The fungi further secrets organic acids that solubilize phosphates and mineral ions, such as iron, magnesium, and manganese. In some embodiments, the biological comprises a species of Trichoderma selected from, but not limited to, T. harzianum, T. atroviride, T. asperellum, T. virens, T. longipile, T. tomentosum, T. viride, T. afroharzianum, and T. hamatum.

### Mycorrhizal Fungi and Glomus

In some embodiments, the biological comprises a mycorrhizal fungi. Mycorrhizal fungi enhance plant access to soil nutrients and water. There are two functional types, arbuscular mycorrhizal fungi (AMF) and ectomycorrhizal fungi (EMF) which partner with plants having different nutrient acquisition strategies (for example, fast N cycling vs. slow N cycling). An example genus of AMF is Glomus. In some embodiments, the biological is a mycorrhizal fungi selected from Glomus intraradices, Glomus mosseae, Glomus aggregatum, Glomus etunicatum, Glomus clarus, and Rhizophagus intraradices.

### Plant Growth-Promoting Rhizobacteria (PGPR)

In some embodiments, the biological comprises a PGPR. PGPR species promote plant growth via direct mechanisms (for example, by improving nutrient acquisition and regulating phytohormones) and indirect mechanisms (for example, by inducing resistance to stressors or competing with a pathogen). In some embodiments, the biological comprises a PGPR species selected from the genera of Acinetobacter, Aeromonas, Agrobacterium, Allorhizobium, Arthrobacter, Azoarcus, Azorhizobium, Azospirillum, Azotobacter, Bacillus, Bradyrhizobium, Burkholderia, Caulobacter, Chromobacterium, Delftia, Enterobacter, Flavobacterium, Frankia, Gluconacetobacter, Klebsiella, Mesorhizobium, Methylobacterium, Micrococcus, Paenibacillus, Pantoea, Pseudomonas, Rhizobium, Serratia, Streptomyces, and Thiobacillus.

### Azospirillum

In some embodiments, the biological comprises an Azospirillum species. Azospirillum species have been shown to increase the yield, drought tolerance, and salt tolerance of crops such as corn, wheat, rice, and sugarcane (see for example G. F. Vogel, et al., Agronomic performance of Azospirillum brasilense on wheat crops, Appl. Res. Agrotechnol., 6 (2013), pp. 111-119; J. E. Garcia, et al., In vitro PGPR properties and osmotic tolerance of different Azospirillum native strains and their effects on growth of maize under drought stress, Microbiological Research 202 (2017) pp 21-29). Axospirillum further promotes plant growth through production of auxins, cytokinins, and gibberellins. In some embodiments, the biological comprises a species of Azospirillum selected from A. brasilense, A. amazonense, A. irakense, A. lipoferum, A. largimobile, A. halopraeferens, A. oryzae, A. canadensis, A. doebereinerae, and A. melinis

### Pseudomonas

In some embodiments, the biological comprises a Pseudomonas species. Pseudomonas species are present in both the rhizosphere as well as the within plant tissues. They have been extensively studied for their roles in plant growth promotion, control of pests and pathogens, and nutrient solubilization (Kumar A., et al., Role of Pseudomonas sp. in Sustainable Agriculture and Disease Management, (2017) pp 195-215). In some embodiments, the biological comprises a species of Pseudomonas selected from P. aeruginosa, P. aureofaciens, P. cepacia (formerly known as Burkholderia cepacia), P. chlororaphis, P. corrugata, P. fluorescens, P. proradix, P. putida, P. rhodesiae, P. syringae, P. protegens, P. chlororaphis, P. segetis, and P. segetis strain P6.

### Bacillus

In some embodiments, the biological comprises a Bacillus species. Bacillus is a diverse group of bacteria in the soil ecosystem, playing roles in nutrient cycling and imparting plant beneficial traits such as stress tolerance (see for example A. K. Saxena et al., “Bacillus species in soil as a natural resource for plant health and nutrition.” 2019. J of App. Microbiology, 128 (5): 1583-1594). In some embodiments, the biological comprises a species of Bacillus selected from B. subtilis, B. velezensis, B. siamensis, B. cereus, B. thuringiensis, Bacillus thuringiensis (var. kurstaki), B. thuringiensis subsp. israelensis, B. thuringiensis subsp. tenebrionis strain SA-10, B. thuringiensis subsp. aizawai, Bacillus thuringiensis strain VBTS 2528, B. licheniformis, B. pumilus, Bacillus pumilus strain QST 2808, B. altitudinis, B. stratosphericus, B. aerius, B. safensis, B. australimaris, B. amyloliquefaciens, B. methylotrophicus, B. megaterium, B. simplex, B. sp. AQ175 (ATCC Accession No. 55608), B. sp. AQ 177 (ATCC Accession No. 55609), B. sp. AQ178 (ATCC Accession No. 53522), B. sphaericus, B. bombysepticus, B. firmus, B. coagulans, B. azotofixans, and B. macerans.

In some embodiments, the biological comprises a soil inoculant comprising Bacillus sp. In some embodiments, the soil inoculant comprises species of Bacillus. In some embodiments, the biological comprises B. subtilis, B. pumilus, B. amyloliquefaciens, B. licheniformis, Paenibacillus chitinolyticus and/or B. laterosporus.

### Methylobacterium

In some embodiments, the biological comprises a Methylobacterium species. Methylobacterium are a genus of non-pathogenic bacteria found in a wide range of environments. A number of species of Methylobacterium have been shown to promote plant growth through their production of plant hormones such as cytokinins, abscisic acid, and indole-3-acetic acid. Of note, they are able to produce high levels of cytokinins and the active trans-Zeatin form (see for example, Palberg, D., et al. A survey of Methylobacterium species and strains reveals widespread production and varying profiles of cytokinin phytohormones. BMC Microbiol 22, 49 (2022)). In some embodiments, the biological comprises a species of Methylobacterium selected from M. gregans, M. adhaesivum, M. aerolatum, M. ajmalii, M. aquaticum, M. aminovorans, M. brachiatum, M. brachythecii, M. bullatum, M. cerastii, M. crusticola, M. currus, M. dankookense, M. durans, M. extorquens, M. frigidaeris, M. fujisawaense, M. funariae, M. gnaphalii, M. goesingense, M. gossipicola, M. haplocladii, M. hispanicum, M. indicum, M. iners, M. isbiliense, M. jeotgali, M. komagatae, M. longum, M. marchantiae, M. mesophylicum, M. nodulans, M. nonmethylotrophicum, M. organophillum, M. oryzae, M. oryzihabitans, M. oxalidis, M. persicinum, M. phyllosphaerae, M. phyllostachyos, M. planium, M. platani, M. pseudosasicola, M. radiotolerans corrig., M. rhodinum, M. segetis, M. soli, M. symbioticum, M. tardum, M. tarhaniae, M. terrae, M. terricola, M. thuringiense, M. trifolii, M. thiyocyanatum, M. variabile, M. zatmanii.

### Gluconacetobacter

In some embodiments, the biological comprises a Gluconacetobacter species. Species of Gluconacetobacter can establish symbiotic relationships with plants and promote growth and nitrogen fixation. In some embodiments, the biological comprises a species of Gluconacetobacter selected from G. azotocaptans, G. diazotrophicus, G. johannae, and G. sacchari.

### Pantoea

In some embodiments, the biological comprises a Pantoea sp. In some embodiments, the biological comprises a species of Pantoea selected from Pantoea agglomerans, Pantoea agglomerans strain C9-1, Pantoea agglomerans strains (ATCC 27155, CCUG 539, CDC 1461-67, CFBP 3845, CIP 57.51, DSM 3493, ICPB 3435, ICMP 12534, JCM 1236, LMG 1286, NCTC 9381), Pantoea allii, Pantoea ananatis, Pantoea anthophila, Pantoea citrea, Pantoea deleyi, Pantoea dispersa, Pantoea eucalypti, Pantoea punctata, Pantoea stewartii, Pantoea terrea, and Pantoea vagans.

### Probelte® Biologicals

In some embodiments, the biological is a product from Probelte®. In some embodiments, the biological is an Agrobiotech product from Probelte®. In some embodiments, the biological is Biopron™ Premium, Bøtrybël™, Bulhnova™, Nemapron™, Strongest™, Belthirul™ M, Belthirul™ F, Belthirul™ S, Belthirul™ 16 SC, or Lepiback™. In some embodiments, the biological is a product listed in the product catalog of Probelte®, which can be retrieved from the world wide web at: probelte.com/wp-content/uploads/2022/02/Probelte_Product_catalogue. pdf. In some embodiments, the biological is Bøtrybël™. In some embodiments, the biological comprises Bacillus amyloliquefaciens. In some embodiments, the biological comprises 10⁸ CFU/mL Bacillus amyloliquefaciens. In some embodiments, the biological is for administration at a dose of 12-15 cc/L as a foliar application every 7-14 days. In some embodiments, the biological is for administration at 5-15 L/ha, 1-5 times. For example, in some embodiments, the biological is for administration 5-7 days after transplanting, 30-40 days after first application, and 50-60 days after first application.

In some embodiments, the biological is a Probelte® product, and it is administered in conjunction with a jasmonate disclosed herein, and it is for administration at the recommended dose according to its product packaging or labeling. In some embodiments, the Probelte® product is administered separately from a jasmonate composition disclosed herein. In some embodiments, the Probelte® product is administered in combination with a jasmonate composition disclosed herein.

In some embodiments, the biological is a composition or microbial strain disclosed in any one of WO-2008113873-A1, WO-2009013596-A2, WO-2009031023-A2, WO-2011036316-A2, WO-2011121408-A1, WO-2008090460-A1, WO-2009027544-A1, WO-2010041096-A1, or WO. 2020216978-A1, each of which is incorporated by reference herein in its entirety.

### Impello® Biologicals

In some embodiments, the biological is an Impello® product. In some embodiments, the biological is a microbial inoculant, biostimulating additive, or nutrient product from Impello®. In some embodiments, the product is Biofuel™, Continuum™, Dune™, Lumina™, Tribus®, of Tundra™. In some embodiments, the product is any of the products available from Impello, a list of which can be retrieved from the world wide web at: impellobio.com/collections/all.

In some embodiments, the biological comprises microbial soil inoculants. In some embodiments, the biological comprises species of B. subtilis, B. pumilus, B. amyloliquefaciens, B. licheniformis, Paenibacillus chitinolyticus and/or B. laterosporus. In some embodiments, the biological comprises species of B. subtilis, B. pumilus, B. amyloliquefaciens, and/or Paenibacillus chitinolyticus. In some embodiments, the biological comprises a commercially available soil inoculant. in some embodiments, the biological comprises Tribus® or Continuum™. In some embodiments, the biological comprises Bacillus subtillis (e.g., at about 4.0×10⁹ CFU/ml), Bacillus pumilus (e.g., at about 4.0×10⁹ CFU/ml), and Bacillus amyloliquefaciens (e.g., at about 2.0×10⁹ CFU/ml). In some embodiments, the biological comprises Paenibacillus chitinolyticus (e.g., at about 10⁶ CFU/mL), Bacillus subtillis (e.g., at about 10⁶ CFU/mL), Bacillus pumilus (e.g., at about 10⁶ CFU/mL), and Bacillus amyloliquefaciens (e.g., at about 10⁶ CFU/mL).

### Methods of Application

In some embodiments, the methods and compositions disclosed herein can be applied to seed, seedling, clone stock, vegetative tissues, root tissues, leaves, flowering tissues, and mature plant parts. The elicitor or composition comprising an elicitor may be applied in liquid or dry form, using a foliar spray, a root drench or a gas to subterranean plant cells and/or aerial plant cells. The elicitor or composition comprising an elicitor may be applied to the soil, to the plant, or to both the soil and the plant. The elicitor or composition comprising an elicitor may be applied to plant parts using methods known in the art, such as foliar spray, atomization, fumigation, or chemigation. The elicitor or composition comprising an elicitor may be applied to the soil using methods known in the art such as irrigation, chemigation, fertigation, or injection. The elicitor or composition comprising an elicitor may be applied to a soil or a water or a carbon dioxide or a fertilizer source, including hydroponic and aeroponic and carbon dioxide injection systems, which is delivered to the plant in a liquid, dry, or gaseous form. In some embodiments, the plant may be grown indoors or outdoors, in a controlled or uncontrolled environment, in fields or in containers. The plant may be grown in soil-based media, soil-less media, or a media containing both soil-less and soil-based components. The plant may be grown in coco, rockwool, peat moss, or other acceptable medias well-known in the art. The plant may be grown with organic (Carbon-based), inorganic (synthetic), or a combination of both, fertilizers, amendments, adjuvants, pesticides, and supplements.

In some embodiments the elicitor or composition comprising an elicitor is applied to immature plants, seeds, or seedlings. In some embodiments, the elicitor or composition comprising an elicitor is applied to mature plants and/or plants in the reproductive stages. In some embodiments, the elicitor or composition comprising an elicitor is applied before harvest. In some embodiments, the elicitor or composition comprising an elicitor is applied between 24 and 72 hours before harvest. When the elicitor or composition comprising an elicitor is applied to growing plant parts or flowers, the same, or a different composition may be applied at a later stage of growth, or before harvest.

In some embodiments, an elicitor or composition comprising an elicitor are used independently or as a mixture to alter the production of valuable primary and/or secondary metabolites by contacting some part of the plant or its environment at one or more distinct timepoints throughout the plant's lifecycle. One or more elicitors may be applied once or more about: every day, every 2 days, every 3 days, every 4 days, every 5 days, every 6 days, every 7 days, every S days, every 9 days, every 10 days, every 11 days, every 12 days, every 13 days, every 14 days, every 15 days, every 16 days, every 17 days, every 18 days, every 19 days, every 20 days, every 21 days, every 22 days, every 23 days, every 24 days, every 25 days, every 26 days, every 27 days, every 28 days, every 29 days, every 30 days, every 31 days, every 32 days, every 33 days, every 34 days, every 35 days, every 36 days, every 37 days, every 38 days, every 39 days, every 40 days, every 41 days, every 42 days, every 43 days, every 44 days, every 45 days, every 46 days, every 47 days, every 48 days, every 49 days, every 50 days, every 51 days, every 52 days, every 53 days, every 54 days, every 55 days, every 56 days, every 57 days, every 58 days, every 59 days, every 60 days, every 61 days, every 62 days, every 63 days, every 64 days, every 65 days, every 66 days, every 67 days, every 68 days, every 69 days, every 70 days, every 71 days, every 72 days, every 73 days, every 74 days, every 75 days, every 76 days, every 77 days, every 78 days, every 79 days, every 80 days, every 81 days, every 82 days, every 83 days, every 84 days, every 85 days, every 86 days, every 87 days, every 88 days, every 89 days, every 90 days, every 91 days, every 92 days, every 93 days, every 94 days, every 95 days, every 96 days, every 97 days, every 98 days, every 99 days, every 100 days, every 101 days, every 102 days, every 103 days, every 104 days, every 105 days, every 106 days, every 107 days, every 108 days, every 109 days, every 110 days, or any combination of those days.

In some embodiments, one or more elicitors may be applied only once during the entire plant life cycle, for example, at pre-veraison stage (berry development phase), or veraison stage (berry ripening phase).

In some embodiments, the elicitor is applied prior to veraison. In some embodiments, the elicitor is applied at or after veraison. In some embodiments, the elicitor is applied between 72 and 24 hours prior to harvest. In some embodiments, the elicitor is applied more than once during the plant lifecycle. In some embodiments, the elicitor is applied every 3 to 10 days.

In some embodiments, the effective amount for Vitis spp. is between 850-1700 ppm applied at an application rate of 100 gallons per acre. In some embodiments, the effective amount of the elicitor is between 1 mM and 10 mM. In some embodiments, the elicitor is applied as a foliar spray or root drench.

### Primary Metabolites

The disclosed compositions and methods may be used to increase crop value by contacting young plants, seeds, clones or scions, vegetative plants, or other non-reproductive plant parts, or reproductive plant parts, to induce a desired response. The value of the crop may be determined by quantifying the concentration of metabolites in plant parts, for example, with mass spectrometry, or by weight or volume measurements, or yield (concentration, weight, density, or relative abundance) of structures or organs, or by other physical or chemical means.

In Vitis spp., the major primary metabolites affecting the taste and quality of grapes are organic acids, amino acids, and sugars. Glucose and fructose are the primary sugars found in wine grapes, and the amount of sugar in wine grapes influences alcohol content after fermentation, as well as sugars that are left over in the wine. Generally, most of the soluble solids measured in grape by density (Brix) are sugars, however one may also directly measure the glucose and fructose levels.

In some embodiments, the compositions and methods can be used to increase the production of valuable metabolites, or to decrease the production of undesirable metabolites, as determined by analysis of plant or plant parts.

In some embodiments, the disclosure teaches a method for increasing Brix in a Vitis vinifera fruit, comprising: applying a composition comprising between 1 mM and 10 mM methyl dihydrojasmonate to a Vitis vinifera plant, plant part, or plant cell, wherein the application of the composition increases Brix in Vitis vinifera fruit compared to untreated controls. In some aspects, the Vitis vinifera plant, plant part, or plant cell is a wine variety. In some aspects, the wine variety selected from Cabernet Sauvignon, Pinot Noir, Merlot, Syrah, Grenache, Sangiovese, Nebbiolo, Tempranillo, and Malbec.

In some aspects, the methods and compositions of the disclosure increase Brix by at least 25%, 30%, 35%, 40%, 45%, 50%, 55%, 60%, 65%, 70%, 75%, 80%, 85%, 90%, or 95%.

In some embodiments, the methods and compositions of the disclosure reduce the content variability of Brix in a population of Vitis vinifera plants.

In addition to primary metabolites, the quality of the grape (and wine resulting therefrom) is determined largely by secondary metabolites.

### Secondary Metabolites

Secondary plant metabolites are compounds which are not required for the growth and reproduction of the organism, but provide some advantage to the organism (bacteria, fungi, and plants) and may be required for survival. For example, a secondary metabolite may attract a pollinator through color or scent, or provide defense from an invading bacterial, viral, or fungal species. They may confer protection from UV radiation, or an insect pest, or aid in wound healing. They are also responsible for the aromas and flavors of plants (which may deter predators). They can be classified based on their chemical structures. Exemplary classes of secondary metabolites include phenolics (tanins, coumarins, flavonoids, chromones and xanthones, stilbenes, lignans), alkaloids, and terpenes.

In some embodiments, the methods and compositions disclosed herein alter the synthesis of a secondary metabolite in a Vitis plant, plant part, or plant cell compared to untreated plants and plant parts. In some embodiments, the method comprises applying an effective amount of at least one elicitor, wherein the elicitor is a jasmonate. In some embodiments, the method comprises applying an effective amount of at least two jasmonates. In some embodiments, the method comprises applying an effective amount of at least three jasmonates.

In some embodiments, the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.

In some embodiments, the at least one elicitor is methyl jasmonate. In some embodiments, the at least one elicitor is methyl dihydrojasmonate. In some embodiments, the at least one elicitor is cis-jasmone. In some embodiments, the at least two jasmonates are methyl jasmonate and methyl dibydrojasmonate. In some embodiments, the at least two jasmonates are methyl jasmonate and cis-jasmone. In some embodiments, the at least two jasmonates are methyl dihydrojasmonate and cis-jasmone. In some embodiments, the at least three jasmonates are methyl jasmonate, methyl dihydrojasmonate, and cis-jasmone.

In some embodiments, the method further comprises applying an effective amount of a non-jasmonate elicitor. In some embodiments, the non-jasmonate elicitor is a salicylate. In some embodiments, the salicylate is methyl salicylate and/or salicylic acid.

Vitis spp. produce a number of secondary metabolites, some having use for medicinal and antimicrobial purposes (Kashif A., et al., Metabolic constituents of grapevine and grape-derived products, Phytochem Rev. 2010; 9 (3): 357-378). Phenolics play a role in the plants response to biotic and abiotic stresses, and contribute to grape pigmentation. In wine making, these phenolics affect the appearance, fragrance, and oraganoleptic qualities (taste, mouth-feel) of the wine. In fact, consumer preference, cost, and score are tied to the amount of phenolic material a wine possesses. The major groups of phenolics in grapevine are simple phenolics, flavonoids, and stilbenoids, discussed each in turn in more detail below.

In some embodiments, methods and compositions disclosed herein alter the synthesis of at least one of a phenolic, alkaloid, and terpene.

### Phenolics

Phenolic compounds are a large group of secondary metabolites, characterized by the presence of at least one phenol group, but may be further grouped as simple phenolics, tannins, coumarins, flavonoids, chromones and xanthones, stilbenes, and lignans. They are an important component of the human diet and have numerous health benefits, including for example, as an antioxidant, antimicrobial, anticancer, anti-inflammatory, and anti-mutagenic. They may also be used in personal care items, and as a food preservative (Kumar N, Goel N. Phenolic acids: Natural versatile molecules with promising therapeutic applications. Biotechnol Rep (Amst). 2019; 24; Lin D, et al. An Overview of Plant Phenolic Compounds and Their Importance in Human Nutrition and Management of Type 2 Diabetes. Molecules. 2016; 21 (10): 1374).

In some embodiments, the methods and compositions disclosed herein alter the production of a phenolic in a Vitis plant, plant part, or plant cell. In some embodiments, the phenolic is a simple phenolic, tannin, coumarin, flavonoid, chromone, xanthone, stilbene, or lignan. In some embodiments, the phenolic is a simple phenolic, flavonoid, or stilbenoid.

### Simple Phenolics

Simple phenolics are so named because they have a single benzene (aromatic) ring. Simple phenolics are primarily stored in cell vacuoles and are released by the crushing mechanism of wine making. One of the most common simple phenolics in grapevine is gallic acid, shown below. Gallic acid may range from between 0.3 to 4.8 mg/l in wine, depending on the grape variety (Pozo-Bayon M A, et al., Study of low molecular weight phenolic compounds during the aging of sparkling wines manufactured with red and white grape varieties. J Agric Food Chem. 2003; 51:2089-2095; Pena-Neira A, et al., A survey of phenolic compounds in Spanish wines of different geographic origin. Eur Food Res Technol. 2000; 210:445-448; Sladkovsky R, et al., High performance liquid chromatography determination of phenolic compounds in wine using off-line isotachophoretic pre-treatment. J Chromatogr A. 2004; 1040:179-184).

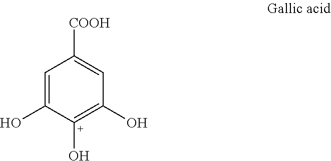

Other common simple phenolics of grapevine include, but are not limited to, gentisic acid, protocatechuic acid, vanillic acid, syringic acids, and p-hydroxybenzoic acid. Derivatives of these include, for example, the ethyl esters of vanillic and p-hydroxybenzoic acid, methyl esters of vanillic and protocatechuic acid, ethyl esters of protocatechuic acid, the glucose ester of vanillic acid (Pozo-Bayon M A, et al., Study of low molecular weight phenolic compounds during the aging of sparkling wines manufactured with red and white grape varieties. J Agric Food Chem. 2003; 51:2089-2095; Vanhoenacker G, et al., Comparison of high performance liquid chromatography-mass spectroscopy and capillary electrophoresis-mass spectroscopy for the analysis of phenolic compounds in diethyl ether extracts of red wines. Chromatographia. 2001; 54:309-315; Baderschneider B, & Winterhalter P. Isolation and characterization of novel benzoates, cinnamates, flavonoids, and lignans from Riesling wine and screening for antioxidant activity. J Agric Food Chem. 2001; 49:2788-2798).

In some embodiments, the methods and compositions disclosed herein alter the production of a simple phenolic in a Vitis plant, plant part, or plant cell. In some embodiments, the simple phenolic is a cinnamate. In some embodiments, the simple phenolic is gallic acid, gentisic acid, protocatechuic acid, vanillic acid, syringic acids, p-hydroxybenzoic acid, and derivatives thereof

### Flavonoids

Flavonoids represent a large family of secondary metabolites having the general structure of two phenyl rings and a heterocyclic ring. Nearly 6000 structures have been identified in plants (Hichri I, et al., Recent advances in the transcriptional regulation of the flavonoid biosynthetic pathway. J Exp Bot. 2011 May; 62 (8): 2465-83). They have diverse biological roles, including for example, antioxidant, anti-inflammatory, and antimicrobial.

Flavonoids are the most abundant polyphenols in the human diet and are considered health-promoting compounds due to their antioxidant and anti inflammatory activities. As such, some flavonoids are extracted from grape and used in health supplements (see for example International Publication No. WO/2020197828 and U.S. Pat. No. 6,544,581). High flavonoid consumption has been correlated to prevention of cancers, cardiovascular diseases, Alzheimer's, and atherosclerosis (Babu et ah, 2009, Hollman and Katan, 1999, Kris-Etherton et ah, 2004).

Flavonoids can be subgrouped into flavones (i.e., apigenin, tangeretin, baicalein, rpoifolin), isoflavones (i.e., genistin, genistein, daidzein, glycitein, daidzin), flavonols (also known as catechins or flavan-3-ols) (i.e., quercetin, myricetin, rutin, morin, kaempferol), flavonones (i.e., hespertin, naringin, naringenin, eriodictyol, hesperidin), anthocyanins (i.e., cyanidin, malvidin, delphinidin, peonidin), and chalcones (i.e., phloretin, arbutin, phlioridzin, chalconaringenin). Among the health benefits of flavonols, kaempferol was found to reduce the risk of chronic diseases including cancer (Chen et ak, 2013), quercetin was linked to increasing the lifespan extension in mammals (Haigis et ak, 2010) and myricetin was found to reduce the risks of cancer and diabetes (Feng et ak, 2015)

Flavonoids in grapevine are commonly found in the skin and seed of the berries. Examples of flavonoids include, for example, flavonols, catechins (flavan-3-ols), anthocyanins, and condensed tannins. Anthocyanins are responsible for the red and pink pigmentation in grape. Anthocyanin accumulation begins at the Veraison stage (the transition from berry growth to berry ripening) and varies depending on the grow conditions (soil, water, climate, etc.). Different varieties of grapevine have different compositions of anthocyanins, but the total amount may range from 500 mg/kg to 3 g/kg of berries. The anthocyanins commonly found in grape include delphinidin, cyanidin, petunidin, peonidin and malvidin 3-glucosides, 3-(6-acetyl)-glucosides and 3-(6-p-coumaroyl)-glucosides, peonidin and malvidin 3-(6-caffeoyl)-glucosides, being malvidin-3-O-glucoside the major anthocyanin present along with its acylated forms. Examples of flavonols, anthocyanins, catechins (flavan-3-ols), and condensed tannins are shown below in Table 3

TABLE 3
Example flavonols, anthocyanins, catechins (flavan-
3-ols), and condensed tannins of grapevine

| Secondary metabolite | Classification |
|---|---|
| Laricitrin, laricitrin 3-O-galactoside | Flavonol |
| Syringetin, syringetin 3-O-galactoside, syringetin-3-O- | Flavonol |
| glucoside | |
| Quercetin, quercetin 3-glucuronide, quercetin 3-rutinoside, | Flavonol |
| quercetin 3-glucoside, dihydroquercetin, 3-O-glucoside of | |
| dihydroquercetin, 3-O-xyloside of dihydroquercetin, 3′-O- | |
| glucoside of dihydroquercetin | |
| myricetin | Flavonol |
| Kaempferol, kaempferol 3-galactoside, kaempferol 3- | Flavonol |
| glucoside, dihydrokaempferol, 3-O-glucoside of | |
| dihydrokaempferol | |
| Isorhamnetin, isorhamnetin 3-glucoside | Flavonol |
| procyanidin B1, procyanidin B2, procyanidin B4, | Flavan-3-ols |
| procyanidin C1 | |
| catechin, gallocatechin, epigallocatechin, epicatechin-3- | Flavan-3-ols |
| gallate | |
| astilbin | dihydroflavonol |
| engeletin | dihydroflavonol |
| 3-caffeoylglucosides of peonidin, cyanidin and delphinidin | anthocyanins |
| pyranoanthocyanins | condensed tannins |

In some embodiments, the methods and compositions disclosed herein alter the production of a flavonoid in a Vitis plant, plant part, or plant cell. In some embodiments, the flavonoid is a flavone, an isoflavone, a flavan-3-ol, a flavonone, an anthocyanin, catechin, or a chalcone. In some embodiments, the flavan-3-ol is kaempferol, quercetin, or myricetin. In some embodiments, the flavan-3-ol is at least one of quercetin-3-glucoside, myricetin, catechin, epicatechin, epigallocatechin, procyanidin B1, procyanidin B2 and epicatechin 3-gallate.

In some embodiments, the disclosure teaches a method for increasing total anthocyanins in a Vitis spp. fruit comprising: applying a composition comprising between 1 mM and 10 mM methyl dibydrojasmonate to a Vitis spp. plant, plant part, or plant cell, wherein the application of the composition increases total anthocyanins in Vitis spp. fruit compared to untreated controls.

In some aspects, the method increases total anthocyanins by at least 8%, 9%, 10%, 11%, 12%, 13%, 14%, 15%, 16%, 17%, 18%, 19%, or 20%, including all values and sub-ranges therebetween.

In some embodiments, methods and compositions disclosed herein reduce the content variability of total anthocyanins in a population of Vitis spp. plants.

In some embodiments, the methods and compositions disclosed here increase total anthocyanins in V. vinifera, V. labrusca, V. rotundifolia, V. amurensis, and hybrids thereof.

In some embodiments, the methods and compositions disclosed herein alter the production of a tannin in a Vitis plant, plant part, or plant cell. In some embodiments, the tannin is a polymer of epicatechin. In some embodiments, the tannin is a polymer of epigallocatechin.

### Stilbenes and Stilbenoids

Stilbenes and their derivatives stilbenoids are composed of two benzene rings joined by ethanol or ethylene. More than 400 stilbenes have been identified (T. Shen, X.-N. Wang, and H.-X. Lou, “Natural stilbenes: an overview,” Natural Product Reports, vol. 26, no. 7, pp. 916-935, 2009).

Stilbenoids (1,2-diarylethenes) are another class of phenolic compounds (non flavonoids) present in grape skin, seeds, and stem. Like other secondary metabolites, stilbenoid content in grapevine can be affected by a number of factors, for example, climate, variety, and pests. Example stilbenoids found in grape are trans-resveratrol (3,5,4′-trihydroxystilbene), cis-piceid, trans-piceid (resveratrol glucosides), and piceatannol (3,4,3′,5′-tetrahydroxy-trans-stilbene). Dimers formed by oligomerization of trans-resveratrol—viniferins have also been identified, such as ε-viniferin, δ-viniferin, α-viniferin. Currently, there is a high demand for stilbenes due to their valuable pharmacological properties and role as phytoalexins.

Resveratrol can represent between 5-10% of the biomass of grape skins, and in wine, the concentration can range from between 0.05 to 25 mg/L. Resveratrol has been shown to protect against cardiovascular disease, and has antioxidant, anti-inflammatory, and anti-aging properties. Studies have also shown anticancer and antidepressant effects (Akinwumi B. C., et al., Biological Activities of Stilbenoids. Int J Mol Sci. 2018; 19 (3): 792). In addition to grapevine, resveratrol is also present in, for example, peanut ((Arachis hypogaea), cranberry (Vaccinium macrocarpon), and other berries, passion fruit, tea, and the roots of Fallopia japonica. (C. Rivière, A. D. Pawlus, and J.-M. Mérillon, “Natural stilbenoids: distribution in the plant kingdom and chemotaxonomic interest in Vitaceae,” Natural Product Reports, vol. 29, no. 11, pp. 1317-1333, 2012).

In some embodiments, the methods and compositions disclosed herein alter the production of a stilbene in a Vitis plant, plant part, or plant cell. In some embodiments, the methods and compositions disclosed herein increase the stilbene content in a Vitis plant, plant part, or plant cell. In some aspects, the stilbene content that is altered or increased is selected from the group consisting of trans-resveratrol (3,5,4′-trihydroxystilbene), cis-piceid, trans-piceid (resveratrol glucosides), and piceatannol (3,4,3′,5′-tetrahydroxy-trans-stilbene) the stilbenoid is resveratrol and/or a viniferin.

### Lignans

Lignans are a complex polymeric material made up of simple phenolics. Examples of some lignans in Vitis spp. include, but are not limited to, isolariciresinol derivatives, neolignans, lariciresinol, 4-O-glucoside, and secoisolariciresinols, (Baderschneider B, Winterhalter P. Isolation and characterization of novel benzoates, cinnamates, flavonoids, and lignans from Riesling wine and screening for antioxidant activity. J Agric Food Chem. 2001 June; 49 (6): 2788-98).

In some embodiments, the methods and compositions disclosed herein alter the production of a lignan in a Vitis plant, plant part, or plant cell.

### Alkaloids

Alkaloids are diverse compounds containing nitrogen in a heterocyclic ring, and have been found in grape seeds. Alkaloids have diverse therapeutic uses including, for example, anesthesia, analgesia, cardiac stimulation, respiratory stimulation and relaxation, vasoconstriction, muscle relaxation and toxicity, as well as antineoplastic, hypertensive and hypotensive properties.

In some embodiments, the methods and compositions disclosed herein alter the production of an alkaloid in a Vitis plant, plant part, or plant cell.

### Terpenes

Terpenes are a large and diverse class of organic compounds, produced by a variety of plants. They are often strong smelling and thus may have had a protective function. Terpenes are derived biosynthetically from units of isoprene, which has the molecular formula C₅H₈. The basic molecular formulae of terpenes are multiples of that, (C₅H₈)ₙ where n is the number of linked isoprene units. The isoprene units may be linked together “head to tail” to form linear chains or they may be arranged to form rings. Non-limiting examples of terpenes include Hemiterpenes, Monoterpenes, Sesquiterpenes, Diterpenes, Sesterterpenes, Triterpenes, Sesquarterpenes, Tetraterpenes, Polyterpenes, and Norisoprenoids.

Terpenoids, a.k.a. isoprenoids, are a large and diverse class of naturally occurring organic chemicals similar to terpenes, derived from five-carbon isoprene units assembled and modified in thousands of ways. Most are multicyclic structures that differ from one another not only in functional groups but also in their basic carbon skeletons. Plant terpenoids are used extensively for their aromatic qualities. They play a role in traditional herbal remedies and are under investigation for antibacterial, antineoplastic, and other pharmaceutical functions. The terpene Linalool for example, has been found to have anti-convulsant properties (Elisabetsky et al., Phytomedicine, May 6 (2): 107-13 1999). Non-limiting examples of terpenoids include, Hemiterpenoids, 1 isoprene unit (5 carbons); Monoterpenoids, 2 isoprene units (10C); Sesquiterpenoids, 3 isoprene units (15C); Diterpenoids, 4 isoprene units (20C) (e.g. ginkgolides); Sesterterpenoids, 5 isoprene units (25C); Triterpenoids, 6 isoprene units (30C) (e.g. sterols); Tetraterpenoids, 8 isoprene units (40C) (e.g. carotenoids); and Polyterpenoid with a larger number of isoprene units.

Terpenoids are mainly synthesized in two metabolic pathways: mevalonic acid pathway (a.k.a. HMG-COA reductase pathway, which takes place in the cytosol) and MEP/DOXP pathway (a.k.a. The 2-C-methyl-D-erythritol 4-phosphate/1-deoxy-D-xylulose 5-phosphate pathway, non-mevalonate pathway, or mevalonic acid-independent pathway, which takes place in plastids).

In some embodiments, the production of terpenes and terpenoids derived from isoprene units, including acyclic, monocyclic, bicyclic, tricyclic, tetracyclic, pentacyclic, hexacyclic, heptacyclic, and octacyclic cyclisations of hemiterpenes, monoterpenes, sesquiterpenes, diterpenes, sesterterpenes, triterpenes, sesquarterpenes, tetraterpenes, and polyterpenes are manipulated independently of each other. In some embodiments, the production of terpenes and terpenoids derived from isoprene units, including acyclic, monocyclic, bicyclic, tricyclic, tetracyclic, pentacyclic, hexacyclic, heptacyclic, and octacyclic cyclisations of hemiterpenes, monoterpenes, sesquiterpenes, diterpenes, sesterterpenes, triterpenes, sesquarterpenes, tetraterpenes, and polyterpenes are manipulated relative to each other.

### Common Terpenes in Grapevine

Over 50 terpenic compounds have been identified in grapes and wine, most of which are monoterpenes. For a review of terpenes and terpene derivatives found in grape and wine see for example J. Maris, “Terpenes in the Aroma of Grapes and Wines: A Review” S. Afr. J. Enol. Vitic., Vol. 4. No. 2. 1983; Sun, L., Zhu, B., Zhang, X. et al. The accumulation profiles of terpene metabolites in three Muscat table grape cultivars through HS-SPME-GCMS. Sci Data 7, 5 (2020); Mahmuda Akter Mele, et al., (2021) Grape terpenoids: flavor importance, genetic regulation, and future potential, Critical Reviews in Food Science and Nutrition, 61:9, 1429-1447.

In some embodiments, the methods and compositions disclosed herein alter the synthesis of one or more terpenes. In some aspects, the terpene is selected from the group consisting of limonene, linalool, geraniol, nerol, terpineol, citronellol, and nerolidol.

### Reducing or Preventing Pest or Pathogen Induced Plant Damage

In some embodiments, the methods and compositions disclosed herein are used to treat, reduce, or prevent plant damage. In some embodiments, plant damage is measured in terms of progression of an infestation or infection. In some embodiments, plant damage is measured in terms of number or percentage of affected plant parts, e.g., leaves, branches, flowers, or fruits. In some embodiments, plant damage is measured in terms of decrease in harvestable plant parts, e.g., leaves, seeds, or fruits. In some embodiments, plant damage is measured in terms of productivity, yield, or other metrics of harvest.

In some embodiments, reduction of damage is measured via a reduction in number of infected leaves, percent of infected leaves, number of infected fruits, percent of infected fruits, number of dead leaves, percent of dead leaves, number of damaged leaves, percent of damaged leaves, number of damaged fruits, percent of damaged fruits, degree of infection, progression of infection, degree of infestation, or progression of infestation.

Insect repellents are generally applied to the plant before the emergence or appearance of insects, or after the emergence or appearance of insects but before the insect density reaches economic threshold, while insecticides are applied after the emergence or appearance of insects, after the insect density reaches the economic threshold for a particular insect species and a particular plant species. Biopesticides may be used as repellants or pesticides.

In some embodiments, the methods and compositions disclosed here are used as a repellent. In some embodiments, the methods and compositions disclosed here are used as a pesticide.

### Grapevine Insect Pests

Insects (Class Insecta) are the most diverse group of animals on the planet and comprise 80% of the world's species. In the U.S., there are 91,000 species of insect, including 30,000 species of beetle, 19,600 species of fly, 18,000 species of ants, bees, and wasps, and 11,750 species of moths and butterflies.

There are a number of pests that affect grapevine that may also be controlled, repelled, or prevented by the compositions and methods disclosed herein. For example, Climbing Cutworms, Grape Berry Moth, Grape Cane Borer, Grape Flea Beetle, Grape Leaffolder, Grape Omnivorous Leafroller, Grape Phylloxera, Grape Root Borer, Grape Rootworm, Grape Tumid Gallmaker, Green June Beetle, Japanese Beetle, Multicolored Asian Lady Beetle, Rose Chafer, Western Grapeleaf Skeletonizer, Leafhoppers, Mealybugs, Mites, and Thrips.

Within the leafhopper category, a number of species are known to cause damage to grapevines, including for example, grape leafhopper (Erythroneura comes), potato leafhopper (Empoasca fabae), Eastern grape leafhopper (Erythroneura comes), glassy-winged sharpshooter (Homalodisca coagulate), three-banded leafhopper (Erythroneura tricincta), Virginia creeper leafhopper (Erythroneura ziczac), Western grape leafhopper (Erythroneura elegantula), and the variegated leafhopper (Erythroneura variabilis) Thresholds for leafhopper vary depending on the generation and species (of insect), type of grape, canopy size, and region

Additionally, chewing and sucking insects are capable of transmitting viral diseases. The transmission may be simply mechanical or may be biological. In the latter case the specific insect and the specific viral pathogen have some kind of association or relationship. In such case, insects are called the “vector” for particular viral pathogen. In case of mechanical transmission the pathogen is simply carried externally or internally by insects. Virus carried biologically by insect vectors are of two types: non-persistent viral pathogen, wherein the viral pathogens require no latent or incubation period in the insect body, and persistent viral pathogen, wherein viral pathogens requiring certain incubation period inside the vector body before they are inoculated or transmitted to healthy host. The insects responsible for transmission of viral diseases are, for example, aphids, jassids (leaf hoppers), whiteflies, mealy bugs, etc. Certain bacterial and several fungal pathogens are also known to be carried by insects (Leach, Insect Transmission of Plant Disease, 2007, Daya Publishing House).

### Grapevine Pathogens

Plants that have been damaged by chewing pests are more susceptible to infection. Additionally, pests can act as vectors, transmitting plant pathogens through the wounds the insect makes. Almost all pathogenic viruses, some protozoa and some nematodes are transmitted by insects. Transmission can also be passive, as in the case of fungal spores on legs, mouthparts, and bodies.

For example, thrips can carry and spread Botrytis spores and infect plants with ‘gray mold.’ Botrytis cinerea is a necrotrophic and saprophytic fungus, killing both living and non-living organic matter to obtain the nutrients it needs to grow. Botrytis can infect over 200 plant species, but has been particularly detrimental to grapevine. Transmission of plant pathogens by biological vectors such as insects is well known in the art (see for example, Agrios, G. “Transmission of Plant Diseases by Insects, University of Florida, available on the world wide web at entnemdept.ufl.edu/capinera/eny5236/pest1/content/03/3_plant_diseases.pdf).

In some embodiments, the methods and compositions disclosed herein prevent or treat Botrytis infections, for example grey mold caused by Botrytis cinerea.

In some embodiments, the methods and compositions disclosed herein prevent transmission of a plant pathogen by deterring plant pests.

In some embodiments, the present disclosure provides methods and compositions for preventing and/or treating a fungal disease.

In some embodiments, the methods and compositions disclosed herein prevent and/or treat powdery mildew infection. In some embodiments, the methods and compositions disclosed herein treat a powdery mildew infection. In some cases, the powdery mildew is Erysiphe necator.

In some embodiments, the methods and compositions disclosed herein prevent and/or treat sour rot. Sour rot is caused by a mixture of fungi, yeast, and bacteria.

Additional grapevine pathogens that may be prevented or controlled by the methods and compositions disclosed herein include, but are not limited to, Plasmopara viticoloa, Agrobacterium vitis, Xylella fastidiosa, Grapevine Leaf Roll associated Viruses, grapevine red blotch-associated virus, grapevine fanleaf virus, arabis mosaic virus. See also Armijo G, et al., Grapevine Pathogenic Microorganisms: Understanding Infection Strategies and Host Response Scenarios. Front Plant Sci. 2016 Mar. 30; 7:382.

In some embodiments, compositions and methods of the disclosure are useful in reducing the damage to host plants, i.e., protecting host plants (e.g., agricultural plants) from one or more bacterial diseases.

In some embodiments, the disclosure teaches a method for treating or preventing a Vitis spp. pest or plant pathogen, the method comprising: applying a composition having between 1 mM and 10 mM methyl dihydrojasmonate to a plant, plant part, or plant cell, wherein application of the composition reduces the percent severity and/or percent incidence of a pest or pathogen compared to untreated plants. In some aspects, the plant pathogen is Botrytis cinerea. In some aspects, the plant pathogen is Aspergillus carbonarius. In some aspects, the plant pathogen is Erysiphe necator.

In some embodiments, the methods disclosed herein reduce the percent severity by at least 20%, 21%, 22%, 23%, 24%, 25%, 26%, 27%, 28%, 29%, 30%, 31%, 32%, 33%, 34%, 35%, 36%, 37%, 38%, 39%, or 40%, including all values and sub-ranges therebetween.

In some embodiments, the methods disclosed herein reduce the percent incidence by at least 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40%, including all values and sub-ranges therebetween.

In some embodiments, the compositions and methods disclosed herein reduce the number of infected leaves, percent of infected leaves, number of infected fruits, percent of infected fruits, number of dead leaves, percent of dead leaves, number of damaged leaves, percent of damaged leaves, number of damaged fruits, percent of damaged fruits, degree of infection, progression of infection, degree of infestation, and/or progression of infestation compared to untreated plants.

### EXAMPLES

### Example 1: Application of MDJ to Grapevine Increases Plant Brix

An eliciting composition and methods of use to alter metabolite production were tested on 6 acres of a Malbec variety planted in 1999 in Napa Valley, California. Plants were spaced 5′×10′ (900 vines per acre) and grouped into randomized blocks of 900 vines per group, with six replicates covering three acres for the treatment group, and six replicates covering three acres for the control group. The treatment group received two applications of 32 oz of MDJ applied at a rate of 100 gallons per acre (2.5 mM), once prior to veraison on Aug. 9, 2021 and again when 5-10% of berries were starting to blush (veraison) using a ground spray rig (backpack sprayer).

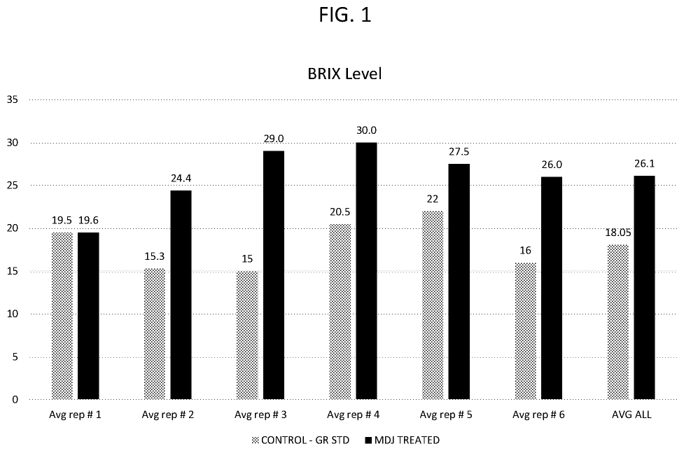

From within each replicate, three plants were selected at random, and 25 leaves from each plant were randomly selected for analysis. The internal sap of the leaves was tested using a refractometer on the days shown below in Table 4 and FIG. 1. Data from each replicate was averaged (25 leaves from each plant, 3 plants). Raw data of averages shown in Table 4 are presented in Tables 5A-5F.

TABLE 4
Application of MDJ increases Brix level

| | | | | MDJ | |
|---|---|---|---|---|---|
| Replicate | | BRIX | CONTROL | TREATED | Percent |
| group # | DATE | METRIC | Averages | averages | increase |
| 1 | 15-Aug | Juice-SAP | 19.5 | 19.6 | — |
| 2 | 22-Sep | Juice-SAP | 15.3 | 24.4 | 59.4% |
| 3 | 30-Sep | Juice-SAP | 15 | 29.0 | 93.3% |
| 4 | 5-Oct | Juice-SAP | 20.5 | 30.0 | 46.3% |
| 5 | 10-Oct | Juice-SAP | 22 | 27.5 | 25% |
| 6 | 30-Oct | Juice-SAP | 16 | 26.0 | 62.5% |

| | | | |
|---|---|---|---|
| Average of all replicate | 18.05 | 26.1 | 44.5% |
| groups sampled | | | |

TABLE 5A
Replicate 1 sampled on Aug. 15, 2021

| | MDJ treated | | Control | | MDJ treated | | Control | | MDJ treated | | Control | |
|---|---|---|---|---|---|---|---|---|---|---|---|---|
| | Plant | | Plant | | Plant | | Plant | | Plant | | Plant | |
| | #1 | Brix | #1 | Brix | #2 | Brix | #2 | Brix | #3 | Brix | #3 | Brix |
| Leaf | 1 | 19.5 | 1 | 18.4 | 1 | 22.8 | 1 | 19.0 | 1 | 19.6 | 1 | 19.5 |
| no. | 2 | 20.0 | 2 | 19.9 | 2 | 19.5 | 2 | 19.5 | 2 | 18.3 | 2 | 19.0 |
| | 3 | 18.9 | 3 | 18.9 | 3 | 19.3 | 3 | 18.7 | 3 | 18.9 | 3 | 18.9 |
| | 4 | 21.0 | 4 | 20.9 | 4 | 18.8 | 4 | 18.8 | 4 | 19.1 | 4 | 19.1 |
| | 5 | 20.0 | 5 | 20.0 | 5 | 22.1 | 5 | 21.1 | 5 | 19.7 | 5 | 19.7 |
| | 6 | 19.0 | 6 | 19.2 | 6 | 19.6 | 6 | 19.6 | 6 | 19.0 | 6 | 19.0 |
| | 7 | 19.8 | 7 | 19.8 | 7 | 18.7 | 7 | 20.0 | 7 | 21.0 | 7 | 20.8 |
| | 8 | 19.5 | 8 | 19.5 | 8 | 18.9 | 8 | 18.9 | 8 | 21.8 | 8 | 21.8 |
| | 9 | 18.7 | 9 | 18.7 | 9 | 19.7 | 9 | 19.7 | 9 | 19.2 | 9 | 19.2 |
| | 10 | 19.0 | 10 | 19.0 | 10 | 19.0 | 10 | 19.0 | 10 | 19.7 | 10 | 19.7 |
| | 11 | 19.4 | 11 | 19.4 | 11 | 21.0 | 11 | 19.0 | 11 | 19.0 | 11 | 19.0 |
| | 12 | 20.5 | 12 | 21.0 | 12 | 20.1 | 12 | 20.1 | 12 | 20.0 | 12 | 19.5 |
| | 13 | 18.9 | 13 | 18.9 | 13 | 19.2 | 13 | 19.2 | 13 | 21.8 | 13 | 21.6 |
| | 14 | 18.4 | 14 | 19.5 | 14 | 21.1 | 14 | 18.8 | 14 | 19.2 | 14 | 19.2 |
| | 15 | 18.9 | 15 | 18.9 | 15 | 18.9 | 15 | 18.9 | 15 | 19.10 | 15 | 19.10 |
| | 16 | 19.8 | 16 | 19.8 | 16 | 19.7 | 16 | 19.7 | 16 | 19.00 | 16 | 20.00 |
| | 17 | 20.5 | 17 | 20.5 | 17 | 19.0 | 17 | 19.6 | 17 | 19.30 | 17 | 19.30 |
| | 18 | 19.5 | 18 | 19.5 | 18 | 21.0 | 18 | 19.7 | 18 | 19.00 | 18 | 19.80 |
| | 19 | 19.9 | 19 | 19.9 | 19 | 21.8 | 19 | 21.5 | 19 | 19.60 | 19 | 19.60 |
| | 20 | 19.4 | 20 | 20.0 | 20 | 19.2 | 20 | 19.2 | 20 | 19.40 | 20 | 19.40 |
| | 21 | 18.9 | 21 | 19.0 | 21 | 19.1 | 21 | 19.1 | 21 | 18.80 | 21 | 18.90 |
| | 22 | 18.9 | 22 | 19.7 | 22 | 19.1 | 22 | 19.1 | 22 | 19.40 | 22 | 19.40 |
| | 23 | 19.8 | 23 | 19.3 | 23 | 18.3 | 23 | 18.3 | 23 | 18.90 | 23 | 18.90 |
| | 24 | 18.7 | 24 | 18.7 | 24 | 18.0 | 24 | 18.1 | 24 | 18.90 | 24 | 19.70 |
| | 25 | 19.9 | 25 | 20.0 | 25 | 18.6 | 25 | 18.6 | 25 | 19.30 | 25 | 19.40 |

| | | | | | | |
|---|---|---|---|---|---|---|
| AVG | 19.5 | 19.5 | 19.7 | 19.3 | 19.5 | 19.6 |
| % BRIX | 77.9 | 78.1 | 78.8 | 77.3 | 77.9 | 78.3 |

TABLE 5B
Replicate 2 sampled on Sep. 22, 2021

| | MDJ treated | | Control | | MDJ treated | | Control | | MDJ treated | | Control | |
|---|---|---|---|---|---|---|---|---|---|---|---|---|
| | Plant | | Plant | | Plant | | Plant | | Plant | | Plant | |
| | #1 | Brix | #1 | Brix | #2 | Brix | #2 | Brix | #3 | Brix | #3 | Brix |
| Leaf | 1 | 22.6 | 1 | 15.1 | 1 | 26.6 | 1 | 15.8 | 1 | 26.20 | 1 | 15.0 |
| no. | 2 | 24.9 | 2 | 14.9 | 2 | 25.3 | 2 | 15.7 | 2 | 22.00 | 2 | 15.5 |
| | 3 | 23.4 | 3 | 15.8 | 3 | 24.8 | 3 | 15.5 | 3 | 24.50 | 3 | 15.2 |
| | 4 | 23.9 | 4 | 15.4 | 4 | 26.5 | 4 | 15.5 | 4 | 25.00 | 4 | 15.1 |
| | 5 | 26.3 | 5 | 15.2 | 5 | 25.5 | 5 | 15.6 | 5 | 19.90 | 5 | 14.9 |
| | 6 | 23.4 | 6 | 15.0 | 6 | 24.8 | 6 | 15.3 | 6 | 22.40 | 6 | 15.0 |
| | 7 | 26.8 | 7 | 14.9 | 7 | 24.9 | 7 | 15.4 | 7 | 23.80 | 7 | 15.3 |
| | 8 | 24.3 | 8 | 15.3 | 8 | 26.7 | 8 | 15.8 | 8 | 25.00 | 8 | 15.2 |
| | 9 | 23.1 | 9 | 14.8 | 9 | 23.8 | 9 | 15.3 | 9 | 19.30 | 9 | 15.1 |
| | 10 | 25.0 | 10 | 15.3 | 10 | 24.0 | 10 | 15.2 | 10 | 24.60 | 10 | 15.5 |
| | 11 | 22.9 | 11 | 15.1 | 11 | 25.0 | 11 | 15.4 | 11 | 24.50 | 11 | 15.6 |
| | 12 | 21.9 | 12 | 15.2 | 12 | 24.8 | 12 | 15.5 | 12 | 19.90 | 12 | 14.8 |
| | 13 | 26.0 | 13 | 15.1 | 13 | 26.3 | 13 | 16.0 | 13 | 26.00 | 13 | 16.0 |
| | 14 | 26.7 | 14 | 14.7 | 14 | 22.7 | 14 | 15.6 | 14 | 20.00 | 14 | 15.2 |
| | 15 | 23.5 | 15 | 14.5 | 15 | 24.6 | 15 | 15.6 | 15 | 19.10 | 15 | 15.5 |
| | 16 | 26.5 | 16 | 15.6 | 16 | 27.0 | 16 | 15.8 | 16 | 22.80 | 16 | 15.8 |
| | 17 | 22.6 | 17 | 15.6 | 17 | 24.5 | 17 | 15.6 | 17 | 23.80 | 17 | 15.6 |
| | 18 | 26.0 | 18 | 15.3 | 18 | 24.5 | 18 | 15.3 | 18 | 26.00 | 18 | 15.3 |
| | 19 | 26.8 | 19 | 15.0 | 19 | 22.8 | 19 | 15.7 | 19 | 19.80 | 19 | 15.0 |
| | 20 | 24.8 | 20 | 14.9 | 20 | 26.5 | 20 | 15.2 | 20 | 26.00 | 20 | 15.2 |
| | 21 | 27.2 | 21 | 14.8 | 21 | 26.4 | 21 | 15.4 | 21 | 20.00 | 21 | 15.0 |
| | 22 | 26.5 | 22 | 15.0 | 22 | 25.0 | 22 | 15.8 | 22 | 19.40 | 22 | 15.8 |
| | 23 | 26.1 | 23 | 15.3 | 23 | 24.1 | 23 | 15.5 | 23 | 27.00 | 23 | 15.5 |
| | 24 | 25.8 | 24 | 15.3 | 24 | 26.7 | 24 | 16.0 | 24 | 24.00 | 24 | 15.8 |
| | 25 | 24.8 | 25 | 15.5 | 25 | 27.7 | 25 | 15.6 | 25 | 23.00 | 25 | 15.6 |

| | | | | | | |
|---|---|---|---|---|---|---|
| AVG | 24.9 | 15.1 | 25.3 | 15.6 | 23.0 | 15.3 |
| % BRIX | 99.5 | 60.6 | 101.0 | 62.2 | 91.8 | 61.4 |

TABLE 5C
Replicate 3 sampled on Sep. 30, 2021

| | MDJ treated | | Control | | MDJ treated | | Control | | MDJ treated | | Control | |
|---|---|---|---|---|---|---|---|---|---|---|---|---|
| | Plant | | Plant | | Plant | | Plant | | Plant | | Plant | |
| | #1 | Brix | #1 | Brix | #2 | Brix | #2 | Brix | #3 | Brix | #3 | Brix |
| Leaf | 1 | 29.5 | 1 | 15.0 | 1 | 28.6 | 1 | 15.0 | 1 | 30.2 | 1 | 14.5 |
| no. | 2 | 30.0 | 2 | 15.0 | 2 | 28.9 | 2 | 14.5 | 2 | 29.5 | 2 | 14.9 |
| | 3 | 29.0 | 3 | 15.3 | 3 | 27.1 | 3 | 14.9 | 3 | 28.9 | 3 | 15.0 |
| | 4 | 28.7 | 4 | 15.2 | 4 | 29.3 | 4 | 15.0 | 4 | 31.9 | 4 | 15.0 |
| | 5 | 24.5 | 5 | 15.8 | 5 | 28.0 | 5 | 16.0 | 5 | 29.8 | 5 | 15.0 |
| | 6 | 23.6 | 6 | 15.1 | 6 | 29.1 | 6 | 14.9 | 6 | 29.2 | 6 | 14.9 |
| | 7 | 26.0 | 7 | 15.2 | 7 | 26.8 | 7 | 15.0 | 7 | 29.3 | 7 | 14.6 |
| | 8 | 28.0 | 8 | 14.8 | 8 | 28.5 | 8 | 14.7 | 8 | 29.9 | 8 | 15.0 |
| | 9 | 27.1 | 9 | 15.7 | 9 | 26.4 | 9 | 14.6 | 9 | 28.5 | 9 | 15.0 |
| | 10 | 26.4 | 10 | 14.8 | 10 | 29.8 | 10 | 15.0 | 10 | 28.5 | 10 | 14.8 |
| | 11 | 28.0 | 11 | 14.5 | 11 | 29.9 | 11 | 15.1 | 11 | 26.7 | 11 | 14.9 |
| | 12 | 29.1 | 12 | 15.5 | 12 | 28.7 | 12 | 14.8 | 12 | 29.5 | 12 | 15.1 |
| | 13 | 25.0 | 13 | 15.4 | 13 | 29.4 | 13 | 15.3 | 13 | 29.9 | 13 | 15.3 |
| | 14 | 28.5 | 14 | 15.2 | 14 | 28.3 | 14 | 15.0 | 14 | 29.9 | 14 | 14.6 |
| | 15 | 26.0 | 15 | 15.0 | 15 | 29.5 | 15 | 15.0 | 15 | 29.5 | 15 | 15.1 |
| | 16 | 25.0 | 16 | 15.3 | 16 | 33.3 | 16 | 14.6 | 16 | 29.9 | 16 | 15.6 |
| | 17 | 29.9 | 17 | 14.9 | 17 | 32.0 | 17 | 15.5 | 17 | 32.0 | 17 | 15.0 |
| | 18 | 28.7 | 18 | 15.3 | 18 | 32.9 | 18 | 15.8 | 18 | 29.0 | 18 | 14.7 |
| | 19 | 29.5 | 19 | 15.2 | 19 | 32.5 | 19 | 14.3 | 19 | 28.7 | 19 | 15.0 |
| | 20 | 30.4 | 20 | 14.8 | 20 | 28.8 | 20 | 15.1 | 20 | 26.9 | 20 | 14.5 |
| | 21 | 31.1 | 21 | 15.2 | 21 | 30.4 | 21 | 15.0 | 21 | 29.8 | 21 | 14.7 |
| | 22 | 33.0 | 22 | 15.3 | 22 | 29.8 | 22 | 15.0 | 22 | 29.8 | 22 | 15.0 |
| | 23 | 29.0 | 23 | 15.2 | 23 | 29.5 | 23 | 14.7 | 23 | 29.9 | 23 | 15.1 |
| | 24 | 23.8 | 24 | 15.0 | 24 | 29.6 | 24 | 15.9 | 24 | 29.6 | 24 | 15.2 |
| | 25 | 29.5 | 25 | 15.0 | 25 | 29.5 | 25 | 15.5 | 25 | 30.0 | 25 | 15.2 |

| | | | | | | |
|---|---|---|---|---|---|---|
| AVG | 28.0 | 15.1 | 29.5 | 15.0 | 29.5 | 14.9 |
| % BRIX | 111.9 | 60.6 | 117.9 | 60.2 | 117.9 | 59.8 |

TABLE 5D
Replicate 4 sampled on Oct. 5, 2021

| | MDJ treated | | Control | | MDJ treated | | Control | | MDJ treated | | Control | |
|---|---|---|---|---|---|---|---|---|---|---|---|---|
| | Plant | | Plant | | Plant | | Plant | | Plant | | Plant | |
| | #1 | Brix | #1 | Brix | #2 | Brix | #2 | Brix | #3 | Brix | #3 | Brix |
| Leaf | 1 | 29.5 | 1 | 20.4 | 1 | 28.7 | 1 | 20.5 | 1 | 32.8 | 1 | 20.8 |
| no. | 2 | 31.8 | 2 | 19.8 | 2 | 28.9 | 2 | 21.0 | 2 | 29.5 | 2 | 20.8 |
| | 3 | 29.6 | 3 | 21.0 | 3 | 29.8 | 3 | 22.0 | 3 | 28.9 | 3 | 18.9 |
| | 4 | 30.6 | 4 | 21.0 | 4 | 29.3 | 4 | 19.8 | 4 | 31.9 | 4 | 21.0 |
| | 5 | 29.8 | 5 | 19.5 | 5 | 28.0 | 5 | 22.0 | 5 | 29.8 | 5 | 19.8 |
| | 6 | 29.0 | 6 | 20.4 | 6 | 29.3 | 6 | 21.2 | 6 | 29.2 | 6 | 22.0 |
| | 7 | 29.5 | 7 | 20.3 | 7 | 26.9 | 7 | 20.8 | 7 | 29.3 | 7 | 21.2 |
| | 8 | 32.3 | 8 | 20.1 | 8 | 28.5 | 8 | 19.9 | 8 | 29.9 | 8 | 20.8 |
| | 9 | 29.5 | 9 | 20.6 | 9 | 29.9 | 9 | 21.0 | 9 | 29.9 | 9 | 19.9 |
| | 10 | 28.7 | 10 | 21.0 | 10 | 29.8 | 10 | 20.5 | 10 | 28.5 | 10 | 21.0 |
| | 11 | 28.9 | 11 | 20.7 | 11 | 30.1 | 11 | 20.4 | 11 | 30.4 | 11 | 20.5 |
| | 12 | 29.5 | 12 | 20.3 | 12 | 28.9 | 12 | 21.6 | 12 | 29.5 | 12 | 19.4 |
| | 13 | 29.7 | 13 | 19.5 | 13 | 29.4 | 13 | 21.0 | 13 | 31.0 | 13 | 20.5 |
| | 14 | 28.9 | 14 | 20.8 | 14 | 28.3 | 14 | 21.6 | 14 | 29.9 | 14 | 21.1 |
| | 15 | 28.8 | 15 | 19.7 | 15 | 29.9 | 15 | 21.8 | 15 | 29.9 | 15 | 21.0 |
| | 16 | 29.8 | 16 | 20.8 | 16 | 33.3 | 16 | 21.0 | 16 | 32.5 | 16 | 21.0 |
| | 17 | 30.0 | 17 | 19.9 | 17 | 33.0 | 17 | 22.0 | 17 | 32.9 | 17 | 20.8 |
| | 18 | 28.9 | 18 | 19.6 | 18 | 32.9 | 18 | 21.5 | 18 | 29.0 | 18 | 21.5 |
| | 19 | 29.5 | 19 | 21.0 | 19 | 32.5 | 19 | 21.3 | 19 | 28.7 | 19 | 20.0 |
| | 20 | 30.4 | 20 | 20.0 | 20 | 28.8 | 20 | 19.9 | 20 | 28.8 | 20 | 20.4 |
| | 21 | 33.3 | 21 | 21.1 | 21 | 30.4 | 21 | 21.0 | 21 | 30.1 | 21 | 19.3 |
| | 22 | 29.9 | 22 | 20.6 | 22 | 29.8 | 22 | 19.9 | 22 | 29.8 | 22 | 21.5 |
| | 23 | 29.7 | 23 | 21.0 | 23 | 29.5 | 23 | 21.0 | 23 | 30.3 | 23 | 21.0 |
| | 24 | 29.9 | 24 | 20.0 | 24 | 29.6 | 24 | 21.8 | 24 | 29.6 | 24 | 21.5 |
| | 25 | 29.5 | 25 | 20.0 | 25 | 29.5 | 25 | 22.0 | 25 | 33.0 | 25 | 21.6 |

| | | | | | | |
|---|---|---|---|---|---|---|
| AVG | 29.9 | 20.4 | 29.8 | 21.1 | 30.2 | 19.9 |
| % BRIX | 119.5 | 81.5 | 119.2 | 84.2 | 120.8 | 79.5 |

TABLE 5E
Replicate 5 sampled on Oct. 10, 2021

| | MDJ treated | | Control | | MDJ treated | | Control | | MDJ treated | | Control | |
|---|---|---|---|---|---|---|---|---|---|---|---|---|
| | Plant | | Plant | | Plant | | Plant | | Plant | | Plant | |
| | #1 | Brix | #1 | Brix | #2 | Brix | #2 | Brix | #3 | Brix | #3 | Brix |
| Leaf | 1 | 27.6 | 1 | 23.8 | 1 | 26.1 | 1 | 20.1 | 1 | 26.5 | 1 | 22.1 |
| no. | 2 | 30.5 | 2 | 23.4 | 2 | 27.2 | 2 | 23.1 | 2 | 24.8 | 2 | 22.9 |
| | 3 | 28.0 | 3 | 22.8 | 3 | 27.0 | 3 | 22.0 | 3 | 25.5 | 3 | 24.8 |
| | 4 | 28.7 | 4 | 24.5 | 4 | 28.5 | 4 | 23.2 | 4 | 26.8 | 4 | 24.8 |
| | 5 | 26.1 | 5 | 22.4 | 5 | 27.5 | 5 | 22.0 | 5 | 24.5 | 5 | 24.7 |
| | 6 | 26.2 | 6 | 20.9 | 6 | 29.1 | 6 | 21.3 | 6 | 26.3 | 6 | 23.7 |
| | 7 | 27.2 | 7 | 20.7 | 7 | 26.8 | 7 | 20.0 | 7 | 25.5 | 7 | 24.6 |
| | 8 | 27.7 | 8 | 22.5 | 8 | 28.5 | 8 | 21.8 | 8 | 25.3 | 8 | 22.4 |
| | 9 | 27.6 | 9 | 22.3 | 9 | 26.4 | 9 | 22.4 | 9 | 28.5 | 9 | 21.8 |
| | 10 | 26.4 | 10 | 24.6 | 10 | 27.8 | 10 | 22.2 | 10 | 26.3 | 10 | 24.8 |
| | 11 | 28.2 | 11 | 25.1 | 11 | 29.9 | 11 | 20.0 | 11 | 26.7 | 11 | 22.8 |
| | 12 | 28.8 | 12 | 22.0 | 12 | 28.7 | 12 | 20.5 | 12 | 25.8 | 12 | 23.8 |
| | 13 | 25.8 | 13 | 23.0 | 13 | 29.4 | 13 | 20.5 | 13 | 27.0 | 13 | 21.8 |
| | 14 | 28.5 | 14 | 22.0 | 14 | 28.3 | 14 | 20.6 | 14 | 26.8 | 14 | 22.7 |
| | 15 | 26.0 | 15 | 23.0 | 15 | 29.5 | 15 | 19.8 | 15 | 28.5 | 15 | 23.5 |
| | 16 | 26.9 | 16 | 22.0 | 16 | 28.6 | 16 | 20.7 | 16 | 28.5 | 16 | 23.8 |
| | 17 | 28.8 | 17 | 21.0 | 17 | 27.5 | 17 | 20.5 | 17 | 25.5 | 17 | 22.6 |
| | 18 | 26.4 | 18 | 20.8 | 18 | 25.0 | 18 | 21.1 | 18 | 26.8 | 18 | 23.3 |
| | 19 | 29.5 | 19 | 22.0 | 19 | 28.7 | 19 | 22.0 | 19 | 28.7 | 19 | 22.8 |
| | 20 | 27.4 | 20 | 21.1 | 20 | 27.6 | 20 | 20.4 | 20 | 26.9 | 20 | 23.5 |
| | 21 | 28.8 | 21 | 22.7 | 21 | 25.9 | 21 | 20.1 | 21 | 29.8 | 21 | 23.6 |
| | 22 | 32.0 | 22 | 21.0 | 22 | 29.8 | 22 | 20.0 | 22 | 27.5 | 22 | 23.6 |
| | 23 | 29.5 | 23 | 19.9 | 23 | 28.4 | 23 | 19.9 | 23 | 26.0 | 23 | 22.5 |
| | 24 | 23.8 | 24 | 21.8 | 24 | 28.0 | 24 | 19.7 | 24 | 28.5 | 24 | 24.9 |
| | 25 | 29.9 | 25 | 23.6 | 25 | 26.0 | 25 | 19.9 | 25 | 27.5 | 25 | 24.5 |

| | | | | | | |
|---|---|---|---|---|---|---|
| AVG | 27.9 | 22.4 | 27.8 | 20.2 | 26.8 | 23.5 |
| % BRIX | 111.4 | 89.4 | 111.4 | 80.6 | 107.3 | 93.8 |

TABLE 5F
Replicate 6 sampled on Oct. 30, 2021

| | MDJ treated | | Control | | MDJ treated | | Control | | MDJ treated | | Control | |
|---|---|---|---|---|---|---|---|---|---|---|---|---|
| | Plant | | Plant | | Plant | | Plant | | Plant | | Plant | |
| | #1 | Brix | #1 | Brix | #2 | Brix | #2 | Brix | #3 | Brix | #3 | Brix |
| Leaf | 1 | 23.8 | 1 | 16.0 | 1 | 29.5 | 1 | 16.1 | 1 | 23.9 | 1 | 16.3 |
| no. | 2 | 24.8 | 2 | 16.4 | 2 | 28.0 | 2 | 16.4 | 2 | 24.9 | 2 | 15.6 |
| | 3 | 26.6 | 3 | 15.7 | 3 | 29.0 | 3 | 14.9 | 3 | 25.0 | 3 | 14.9 |
| | 4 | 23.4 | 4 | 15.6 | 4 | 28.7 | 4 | 15.0 | 4 | 25.0 | 4 | 15.9 |
| | 5 | 23.8 | 5 | 15.6 | 5 | 24.5 | 5 | 15.5 | 5 | 23.1 | 5 | 15.8 |
| | 6 | 24.0 | 6 | 15.5 | 6 | 24.1 | 6 | 16.3 | 6 | 22.9 | 6 | 15.6 |
| | 7 | 26.0 | 7 | 15.6 | 7 | 26.0 | 7 | 16.7 | 7 | 28.1 | 7 | 15.9 |
| | 8 | 25.0 | 8 | 16.3 | 8 | 28.0 | 8 | 16.4 | 8 | 22.9 | 8 | 16.7 |
| | 9 | 24.0 | 9 | 15.6 | 9 | 27.1 | 9 | 15.9 | 9 | 25.8 | 9 | 16.2 |
| | 10 | 25.1 | 10 | 15.8 | 10 | 26.4 | 10 | 16.2 | 10 | 26.9 | 10 | 15.5 |
| | 11 | 26.6 | 11 | 15.9 | 11 | 28.0 | 11 | 16.6 | 11 | 25.5 | 11 | 16.2 |
| | 12 | 25.6 | 12 | 15.8 | 12 | 29.1 | 12 | 16.7 | 12 | 25.6 | 12 | 15.8 |
| | 13 | 24.5 | 13 | 15.6 | 13 | 25.5 | 13 | 16.5 | 13 | 26.2 | 13 | 15.5 |
| | 14 | 24.8 | 14 | 15.9 | 14 | 28.5 | 14 | 16.3 | 14 | 23.9 | 14 | 16.2 |
| | 15 | 26.0 | 15 | 16.7 | 15 | 26.0 | 15 | 16.1 | 15 | 28.8 | 15 | 15.7 |
| | 16 | 24.7 | 16 | 16.2 | 16 | 28.7 | 16 | 15.8 | 16 | 26.3 | 16 | 15.6 |
| | 17 | 23.9 | 17 | 15.5 | 17 | 26.9 | 17 | 16.5 | 17 | 27.2 | 17 | 15.6 |
| | 18 | 22.8 | 18 | 16.2 | 18 | 29.8 | 18 | 16.1 | 18 | 27.3 | 18 | 15.5 |
| | 19 | 24.5 | 19 | 15.8 | 19 | 29.8 | 19 | 16.6 | 19 | 26.1 | 19 | 15.6 |
| | 20 | 25.0 | 20 | 15.8 | 20 | 29.9 | 20 | 16.3 | 20 | 24.6 | 20 | 15.5 |
| | 21 | 24.0 | 21 | 15.6 | 21 | 28.5 | 21 | 16.4 | 21 | 25.7 | 21 | 16.1 |
| | 22 | 25.5 | 22 | 15.8 | 22 | 27.3 | 22 | 15.5 | 22 | 25.6 | 22 | 16.0 |
| | 23 | 25.0 | 23 | 15.2 | 23 | 24.9 | 23 | 16.8 | 23 | 29.9 | 23 | 15.9 |
| | 24 | 26.5 | 24 | 16.2 | 24 | 26.6 | 24 | 15.8 | 24 | 28.4 | 24 | 16.8 |
| | 25 | 24.0 | 25 | 16.6 | 25 | 27.3 | 25 | 16.6 | 25 | 25.4 | 25 | 15.5 |

| | | | | | | |
|---|---|---|---|---|---|---|
| AVG | 24.8 | 15.9 | 27.5 | 16.2 | 25.8 | 15.8 |
| % BRIX | 99.2 | 63.5 | 110.1 | 64.6 | 103.2 | 63.3 |

As shown by the data in the tables presented above and in FIG. 1, two applications of MDJ resulted in an increase in plant Brix.

### Example 2: Application of MDJ to Grapevine Alters Metabolites in Wine Grape Juice

200 grapes were randomly selected from the MDJ treated group and control group of the study described above in Example 1. Samples were pooled from each group and juice was prepared for winemaking used standard practices. The juice was analyzed for several key metabolites important for wine making (Table 6). All samples were run on Agilent HPLC with UV detection for the compounds listed below. Between 50 μL-100 μL was injected into the machine per sample.

TABLE 6
Key metabolites in wine grape juice in MDJ and control berries

| Metabolite | Malbec Control (mg/L) | Malbec MDJ treated (mg/L) |
|---|---|---|
| Catechin | 25 | 28 |
| Quercetin glycosides | 42 | 23 |
| Tannin | 403 | 393 |
| Polymeric anthocyanins | 23 | 24 |
| Total anthocyanins | 1568 | 1697 |
| Catechin/tannin index | 0.062 | 0.071 |
| Polymeric anthocyanins/tannin index | 0.057 | 0.061 |

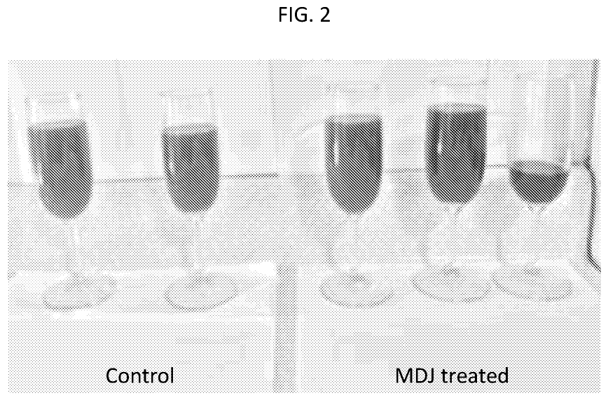

As shown above in Table 6, total anthocyanins, quercetin glycosides, and flavonoids were altered in the MDJ treatment group. Specifically, total anthocyanins increased approximately 8%. As shown in FIG. 2, grape wine juice from the MDJ treatment group had a richer, darker red color than the control group. These results show that treating grapevines with MDJ has the potential to produce higher quality wine.

### Example 3: Control of Botrytis on Grapevine-2021 Field Trials

MDJ was applied to fields of grape to investigate the efficacy of MDJ in preventing bunch rot on (Botrytis cinerea) and powdery mildew (Erysiphe necator) on grapes. A composition comprising 22.6% w/v MDJ, 49.8% v/v TWEEN-20, and water was diluted at a rate of 32 oz. (1 liter) per 50 gallons of water (approximately a 5 mM solution of MDJ). The composition was then applied (at a rate of 50 gallons per acre) to three acres (1245 vines/acre) of a cabernet sauvignon variety grown in Napa Valley, CA. There was a total of four applications between June and September using a ground spray rig.

Several leaf and fruit samples were collected to access the presence of powdery mildew under the microscope and compared to leaf and fruit of plants treated with the grower standard. The MDJ treatment exhibited the same, or better, control of powdery mildew as the grower standard.

To investigate the prevalence of Botrytis, the enzyme laccase was analyzed. Laccase can negatively impact wine by causing premature browning of bottled white wine and color degradation in red wine. The MDJ treated group had 2 units/ml, whereas the control (grower standard) had 5 units/ml. This level in the control group means that Botrytis problems can be expected during the wine making process, whereas in the MDJ treated group, the value of 2 units/ml means there will be no issues with Botrytis during the wine making process.

While the MDJ composition was applied at a rate of 32 oz per acre, the composition may be applied anywhere between 16 and 64 oz per acre (approximately between 2.5 mM and 10 mM MDJ).

### Example 4: Control of Botrytis on Grapevine-2022 Field Trials

Similar to Example 3 above, additional field trials were conducted in 2022 to investigate the efficacy of MDJ in preventing bunch rot (Botrytis cinerea). The objective of this trial was to evaluate the fungicidal efficacy of MDJ at 32 oz and 48 oz/A against Botrytis cinerea on wine grapes. Serenade® Opti at 16 oz/A was included for comparative purposes. Pro 90 a NIS with anti-foaming agent was included with each treatment at 2 oz/100 gal. The trial was conducted on 21-year-old Carignane grapes (Vitis vinifera).

The first of three foliar applications was initiated June 22^{nd} (prior to veraison) followed a month later (July 21^{st} when fruit was at early (5 to 10%) veraison, then at 40% veraison on August 1^{st}. Applications were made using a backpack mistblower based on a spray volume of 80 gallons per acre. As a separate control of Erysiphe necator (powdery mildew), a maintenance fungicide program of two applications in June of fenarimol (4 oz/A) followed by two applications of fenarimol+Quintec (6 oz/A) at 2 week intervals was applied.

Temperatures throughout the trial ranged from highs of 89 to 104 degrees and lows of 50 to 66 degrees F. All treatments provided good crop safety with no phytotoxicity observed. Assessments were based on visual observation of the percent disease incidence and severity at each evaluation.

Botrytis didn't show up in the plots until 6 days after the second application (6DAB). Evaluations after this point showed very good to significant control of Botrytis by all of the treatments. There was a positive rate response by the MDJ Elicitor treatments. The higher rate of MDJ provided numerically better control of Botrytis incidence and severity, with significantly better control noted at 7 and 14 days after the third treatment (7 and 14DAC).

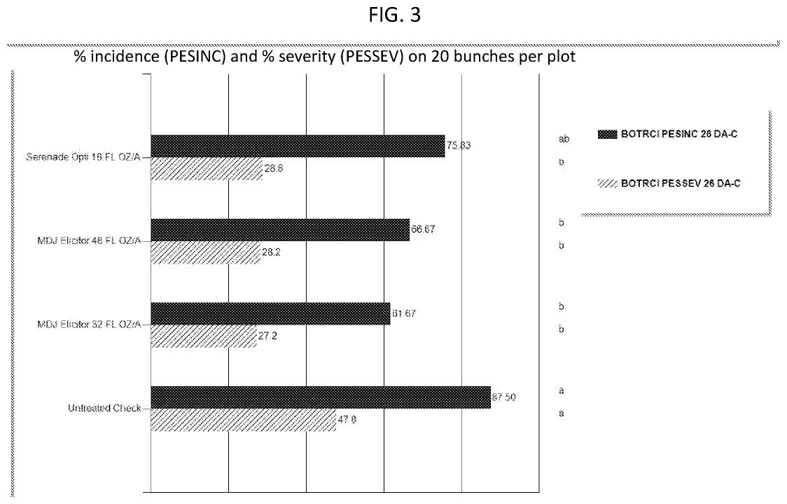

Based on final assessments 26 days after the third application (26DAC), which examined 20 bunches per plot for disease incidence and severity, MDJ Elicitor at both rates provided significantly better B. cinerea suppression (disease incidence) than untreated grapes, with the low rate of MDJ actually providing significantly better control of Botrytis incidence compared to the Serenade® Opti standard (FIG. 3). As shown in FIG. 3, the treatment with MDJ reduced the incident percentage by between approximately 24% to approximately 30%, and reduced the percent severity by between approximately 41% to 43%.

### Example 5: MDJ Controls Sour Rot (Aspergillus carbonarius) and Enhances Grape Quality in Vitis labrusca—2022 Field Trials

Field trials were conducted in California 2022 (a dry year) to investigate the efficacy of MDJ in preventing Sour Rot caused by Aspergillus carbonarius (also known as summer bunch rot, abbreviated ASPECA in Table 7). Black seedless grapes (Vitis labrusca) were used in this trial. Four vines were used per plot. The plots were arranged in a randomized complete block design with six replicates (plots) per treatment. The plots were sprayed five times (ABCDE) at a rate of 500 gal/AC.

Treatments consisted of MDJ at 32 oz and 48 oz/A. A treatment of Regalia® at 1.5 qt/100 gal and Stargus® at 2 qt/100 gal was included for comparative purposes. Application D occurred at 5-10% veraison. Application E occurred at 40% veraison.

Botrytis and powdery mildew were absent for the trial. An evaluation of sour rot was completed before the harvest. The area of an infected cluster was estimated into a percentage and categorized into three levels of severity: low (<40%), medium (41%-50%), and high (>51%). The majority of individual infected clusters had low severity. The higher rate of MDJ Elicitor (48 oz/A) was the most effective at controlling sour rot compared to the rest of the treatments.

A randomly selected sample of approximately twenty wine grapes was used to evaluate the Brix and titratable acid. Another randomly selected sample (>500 g) was shipped to ETS Laboratories (Paso Robles, CA) for a red grape panel analysis (catechin, quercetin glycosides, tannin, polymeric anthocyanins, total anthocyanins, catechin/tannin index, and polymeric anthocyanins/tannin index). An increase in fruit Brix and catechin was observed in MDJ treated plants (Table 7). Total anthocyanins increased over 17% (449.1 in untreated controls compared to 529.3 in the group treated with 48 oz/A MDJ). An increase in quercetin glycosides, tannin, and polymeric anthocyanins, was also observed in MDJ treated plants (Table 8), as well as titratable acid (Table 9).

TABLE 7
Evaluation of sour rot incidence and severity, Brix, and catechin in black seedless grapes

| Pest Type | | | | | D, Disease | D, Disease | D, Disease | D, Disease | | |
|---|---|---|---|---|---|---|---|---|---|---|
| Pest Code | | | | | ASPECA | ASPECA | ASPECA | ASPECA | | |
| Pest Name | | | | | bunch rot | bunch rot | bunch rot | bunch rot | | |
| | | | | | of gr> | of gr> | of gr> | of gr> | | |
| Crop Type, Code | | | | | C, VITSS | C, VITSS | C, VITSS | C, VITSS | C, VITSS | C, VITSS |
| Crop Name | | | | | Grape | Grape | Grape | Grape | Grape | Grape |
| Rating Date | | | | | Aug. 10, | Aug. 10, | Aug. 10, | Aug. 10, | Aug. 11, | Aug. 18, |
| | | | | | 2022 | 2022 | 2022 | 2022 | 2022 | 2022 |
| SE Description | | | | | infected | Low | Medium | High | | catechin |
| | | | | | cluste> | | | | | |
| Part Rated | | | | | CLUSTR | CLUSTR | CLUSTR | CLUSTR | FRUIT | FRUIT |
| Rating Type | | | | | PESINC | PESSEV | PESSEV | PESSEV | BRIX | |
| Rating Unit/Min/Max | | | | | NUMBER | NUMBER | NUMBER | NUMBER | %, 0, 100 | mg/L |
| Number of Subsamples | | | | | 1 | 1 | 1 | 1 | 1 | 1 |
| Trt | Treatment | | Rate | Appl | | | | | | |
| No. | Name | Rate | Unit | Code | 1* | 2* | 3* | 4* | 5* | 6* |
| 1 | Untreated | | | ABCDE | 15.7— | 8.5— | 6.7— | 0.5— | 18.150— | 1.0b |
| | Check | | | | | | | | | |
| 2 | MDJ Elicitor | 32 | oz/a | ABCDE | 13.8— | 7.2— | 5.3— | 1.3— | 19.080— | 0.8b |
| 3 | elicitor | 48 | oz/a | ABCDE | 12.3— | 6.2— | 5.3— | 0.8— | 19.560— | 2.6a |
| 4 | Regalia ® | 1.5 | qt/100 gal | ABCDE | 13.2— | 8.7— | 4.3— | 0.2— | 18.207— | 2.3ab |
| | Stargus ® | 2 | qt/100 gal | ABCDE | | | | | | |

| | | | | | | |
|---|---|---|---|---|---|---|
| LSD P = .05 | 3.78 | 2.52 | 2.55 | 1.18 | 1.7247 | 1.11 |
| Standard Deviation | 3.07 | 2.05 | 2.07 | 0.96 | 1.4015 | 0.87 |
| CV | 22.32 | 26.9 | 38.28 | 135.37 | 7.47 | 49.79 |
| Levene's F\hat{ } | 0.119 | 0.11 | 0.768 | 0.838 | 0.731 | 0.618 |
| Levene's Prob(F) | 0.948 | 0.954 | 0.525 | 0.489 | 0.545 | 0.613 |
| Shapiro-Wilk\hat{ } | 0.949 | 0.9266 | 0.9728 | 0.958 | 0.9721 | 0.9493 |
| P(Shapiro-Wilk)\hat{ } | 0.2582 | 0.0818 | 0.7353 | 0.4003 | 0.718 | 0.3564 |
| Skewness\hat{ } | −0.4507 | −0.9554 | −0.3947 | 0.0511 | −0.2947 | −0.3613 |
| P(Skewness)\hat{ } | 0.3779 | 0.0692 | 0.439 | 0.9197 | 0.5623 | 0.5189 |
| Kurtosis\hat{ } | −0.8109 | 0.8994 | −0.0923 | −0.95 | −0.4814 | −0.7624 |
| P(Kurtosis)\hat{ } | 0.4138 | 0.3655 | 0.9253 | 0.3396 | 0.6259 | 0.4829 |
| Replicate F | 4.097 | 0.826 | 3.760 | 1.024 | 0.760 | 0.812 |
| Replicate Prob(F) | 0.0152 | 0.5506 | 0.0209 | 0.4383 | 0.5922 | 0.5648 |
| Treatment F | 1.279 | 1.990 | 1.279 | 1.616 | 1.446 | 6.287 |
| Treatment Prob(F) | 0.3173 | 0.1588 | 0.3175 | 0.2275 | 0.2690 | 0.0096 |

TABLE 8
Evaluation of quercetin glycosides, tannin, polymeric anthocyanins. total anthocyanins,
catechin/tannin index, and polymeric anthocyanins/tannin index in black seedless grapes

| Crop Type, Code | | | | | C, VITSS | C, VITSS | C, VITSS | C, VITSS | C, VITSS | C, VITSS |
|---|---|---|---|---|---|---|---|---|---|---|
| Crop Name | | | | | Grape | Grape | Grape | Grape | Grape | Grape |
| Rating Date | | | | | Aug. 18, 2022 | Aug. 18, 2022 | Aug. 18, 2022 | Aug. 18, 2022 | Aug. 18, 2022 | Aug. 18, 2022 |
| SE Description | | | | | quercetin | tannin | polymeric | total | catechin/ | polymeric |
| | | | | | glyco> | | antho> | anthocyan> | tanin | athoc> |
| Part Rated | | | | | FRUIT | FRUIT | FRUIT | FRUIT | FRUIT | FRUIT |
| Rating Type | | | | | | | | | INDEX | INDEX |
| Rating Unit/Min/Max | | | | | mg/L | mg/L | mg/L | mg/L | | |
| Number of Subsamples | | | | | 1 | 1 | 1 | 1 | 1 | 1 |
| Trt | Treatment | | Rate | Appl | | | | | | |
| No. | Name | Rate | Unit | Code | 7* | 8* | 9* | 10* | 11* | 12* |
| 1 | Untreated | | | ABCDE | 83.4— | 428.4— | 14.1— | 449.1— | 0.0— | 0.0330— |
| | Check | | | | | | | | | |
| 2 | MDJ Elicitor | 32 | oz/a | ABCDE | 89.8— | 432.0— | 13.5— | 388.3— | 0.0— | 0.0312— |
| 3 | MDJ elicitor | 48 | oz/a | ABCDE | 113.2— | 483.2— | 14.7— | 529.3— | 0.0— | 0.0304— |
| 4 | Regalia ® | 1.5 | qt/100 gal | ABCDE | 95.8— | 420.7— | 14.6— | 439.9— | 0.0— | 0.0338— |
| | Stargus ® | 2 | qt/100 gal | ABCDE | | | | | | |

| | | | | | | |
|---|---|---|---|---|---|---|
| LSD P = .05 | 31.64 | 71.54 | 4.11 | 155.39 | — | 0.00528 |
| Standard Deviation | 24.90 | 56.30 | 3.24 | 122.28 | 0.00 | 0.00416 |
| CV | 26.19 | 12.67 | 23.19 | 27.3 | 0.0 | 13.3 |
| Levene's F\hat{ } | 0.359 | 1.031 | 0.53 | 0.573 | — | 0.113 |
| Levene's Prob(F) | 0.784 | 0.405 | 0.668 | 0.641 | — | 0.951 |
| Shapiro-Wilk\hat{ } | 0.9618 | 0.9578 | 0.9536 | 0.9581 | — | 0.9486 |
| P(Shapiro-Wilk)\hat{ } | 0.5795 | 0.5008 | 0.4252 | 0.5072 | — | 0.3466 |
| Skewness\hat{ } | −0.5409 | 0.2054 | 0.6026 | 0.3669 | — | 0.1929 |
| P(Skewness)\hat{ } | 0.3375 | 0.7128 | 0.2867 | 0.5125 | — | 0.7295 |
| Kurtosis\hat{ } | 0.0322 | −0.9699 | −0.2144 | −0.3827 | — | −1.1092 |
| P(Kurtosis)\hat{ } | 0.9762 | 0.374 | 0.8426 | 0.7234 | — | 0.3108 |
| Replicate F | 2.812 | 4.230 | 1.893 | 1.192 | 0.000 | 0.733 |
| Replicate Prob(F) | 0.0711 | 0.0217 | 0.1754 | 0.3737 | 1.0000 | 0.6140 |
| Treatment F | 1.321 | 1.078 | 0.150 | 1.090 | 0.000 | 0.745 |
| Treatment Prob(F) | 0.3170 | 0.3984 | 0.9277 | 0.3938 | 1.0000 | 0.5476 |

TABLE 9
Evaluation of titratable acid in black seedless grapes

| Crop Type, Code | C, VITSS |
|---|---|
| Crop Name | Grape |
| Rating Date | Sep. 8, 2022 |
| SE Description | Titratable Acid> |
| Part Rated | FRUIT |
| Rating Type | CONTIA |
| Rating Unit/Min/Max | g/L |
| Number of Subsamples | 1 |

| Trt No. | Treatment Name | Rate | Rate Unit | Appl Code | |
|---|---|---|---|---|---|
| 1 | Untreated Check | | | ABCDE | 13* |
| 2 | MDJ Elicitor | 32 | oz/a | ABCDE | 5.83— |
| 3 | MDJ elicitor | 48 | oz/a | ABCDE | 6.67— |
| 4 | Regalia ® | 1.5 | qt/100 gal | ABCDE | 6.42— |
| | Stargus ® | 2 | qt/100 gal | ABCDE | 6.33— |

| | |
|---|---|
| LSD P = .05 | 1.011 |
| Standard Deviation | 0.821 |
| CV | 13.01 |
| Levene's F\hat{ } | 0.797 |
| Levene's Prob(F) | 0.51 |
| Shapiro-Wilk\hat{ } | 0.9681 |
| P(Shapiro-Wilk)\hat{ } | 0.6201 |
| Skewness\hat{ } | 0.2236 |
| P(Skewness)\hat{ } | 0.6597 |
| Kurtosis\hat{ } | −0.513 |
| P(Kurtosis)\hat{ } | 0.6035 |
| Replicate F | 3.735 |
| Replicate Prob(F) | 0.0214 |
| Treatment F | 1.087 |
| Treatment Prob(F) | 0.3849 |

### Example 6: MDJ Controls Sour Rot (Aspergillus carbonarius) and Enhances Grape Quality in Vitis vinifera×Vitis labrusca Kyoho Grape Variety—2022 Field Trials

Field trials were conducted in California 2022 (a dry year) to investigate the efficacy of MDJ in preventing Sour Rot caused by Aspergillus carbonarius (also known as summer bunch rot, abbreviated ASPECA in Table 10). Kyoho grapes (Vitis vinifera×Vitis labrusca) were used in this trial. Three vines were used per plot. The plots were arranged in a randomized complete block design with six replicates (plots) per treatment (24 plots total). The plots were sprayed four times (ABCD) at a rate of 500 gal/AC.

Treatments consisted of MDJ at 32 oz and 48 oz/A. A treatment of Regalia® at 1.5 qt/100 gal and Stargus® at 2 qt/100 gal was included for comparative purposes.

Botrytis and powdery mildew were absent for the trial. An evaluation of sour rot was completed before the harvest. The area of an infected cluster was estimated into a percentage and categorized into three levels of severity: low (<40%), medium (41%-50%), and high (>51%). The majority of individual infected clusters had low severity. The lower rate of MDJ Elicitor (32 oz/A) showed the highest efficacy in controlling sour rot compared to the rest of the treatments.

Unexpectedly, the higher rate of MDJ (48 oz/A) statistically reduced the Brix level compared to other treatments. Additionally, both rates of MDJ application had significantly more grapes per cluster than the standard control (Regalia® and Stargus®), however MDJ treatment did not significantly affect the weight, diameter, or pH of individual grapes (Table 11).

TABLE 10
Evaluation of sour rot incidence and severity, and the average weight of cluster per treatment in Kyoho grapes

| Pest Type | | | | | D, Disease | D, Disease | D, Dise ase | D, Disease | |
|---|---|---|---|---|---|---|---|---|---|
| Pest Code | | | | | ASPECA | ASPECA | ASPECA | ASPECA | |
| Pest Scientific Name | | | | | Aspergillus car> | Aspergillus car> | Aspergillus car> | Aspergillus car> | |
| Pest Name | | | | | bunch rot of gr> | bunch rot of gr> | bunch rot of gr> | bunch rot of gr> | |
| Crop Type, Code | | | | | C, VITSS | C, VITSS | C, VITSS | C. VITSS | C, VITSS |
| BBCH Scale | | | | | BGRA | BGRA | BGRA | BGRA | BGRA |
| Crop Scientific Name | | | | | Vitis sp. | Vitis sp. | Vitis sp. | Vitis sp. | Vitis sp. |
| Crop Name | | | | | Grape | Grape | Grape | Grape | Grape |
| Rating Date | | | | | Aug. 17, 2022 | Aug. 17, 2022 | Aug. 17, 2022 | Aug. 17, 2022 | Aug. 17, 2022 |
| SE Description | | | | | Incidence per p> | Low | Medium | High | Average Weight > |
| Part Rated | | | | | CLUSTR | CLUSTR | CLUSTR | CLUSTR | CLUSTR |
| Rating Type | | | | | PESINC | PESSEV | PESSEV | PESSEV | WEIGHT |
| Rating Unit/Min/Max | | | | | number | number | number | number | g |
| Trt | Treatment | | Rate | Appl | | | | | |
| No. | Name | Rate | Unit | Code | 1* | 2* | 3* | 4* | 5* |
| 1 | Untreated | | | ABCD | 1.5— | 1.3— | 0.2— | 0.0— | 207.510a |
| | Check | | | | | | | | |
| 2 | MDJ Elicitor | 32 | oz/a | ABCD | 0.8— | 0.8— | 0.0— | 0.0— | 234.287a |
| 3 | MDJ Elicitor | 48 | oz/a | ABCD | 1.2— | 0.8— | 0.3— | 0.0— | 246.350a |
| 4 | Regalia ® | 1.5 | qt/100 gal | ABCD | 1.2— | 1.2— | 0.0— | 0.0— | 171.175b |
| | Stargus ® | 2 | qt/100 gal | ABCD | | | | | |

| | | | | | |
|---|---|---|---|---|---|
| LSD P = .05 | 1.92 | 1.59 | 0.58 | — | 35.9198 |
| Standard Deviation | 1.56 | 1.29 | 0.47 | 0.00 | 29.1890 |
| CV | 134.01 | 124.24 | 374.76 | 0.0 | 13.59 |
| Levene's F\hat{ } | 0.265 | 0.191 | 0.274 | — | 1.28 |
| Levene's Prob(F) | 0.85 | 0.901 | 0.844 | — | 0.308 |
| Shapiro-Wilk\hat{ } | 0.9099* | 0.9086* | 0.8153* | — | 0.9489 |
| P(Shapiro-Wilk)\hat{ } | 0.035* | 0.033* | 0.0005* | — | 0.2571 |
| Skewness\hat{ } | 0.9484 | 0.9001 | 1.8616* | — | −0.0582 |
| P(Skewness)\hat{ } | 0.0711 | 0.0857 | 0.0011* | — | 0.9085 |
| Kurtosis\hat{ } | 0.2853 | 0.1157 | 5.4282* | — | 0.4306 |
| P(Kurtosis)\hat{ } | 0.7723 | 0.9065 | 0.0* | — | 0.6626 |
| Replicate F | 0.600 | 0.562 | 0.797 | 0.000 | 3.447 |
| Replicate Prob(F) | 0.7008 | 0.7275 | 0.5683 | 1.0000 | 0.0284 |
| Treatment F | 9.182 | 0.224 | 0.696 | 0.000 | 7.820 |
| Treatment Prob(F) | 0.9071 | 0.8783 | 0.5686 | 1.0000 | 0.0022 |

TABLE 11
Evaluation of individual grape weight diameter grapes per cluster pH, and Brix in Kyoho grapes

| Crop Type, Code | | | | | C, VITSS | | C, VITSS | | C, VITSS | | C, VITSS | | C, VITSS | |
|---|---|---|---|---|---|---|---|---|---|---|---|---|---|---|
| BBCH Scale | | | | | BGRA | | BGRA | | BGRA | | BGRA | | BGRA | |
| Crop Scientific Name | | | | | Vitis sp. | | Vitis sp. | | Vitis sp. | | Vitis sp. | | Vitis sp. | |
| Crop Name | | | | | Grape | | Grape | | Grape | | Grape | | Grape | |
| Rating Date | | | | | Aug. 17, 2022 | | Aug. 17, 2022 | | Aug. 17, 2022 | | Aug. 17, 2022 | | Aug. 17, 2022 | |
| SE Description | | | | | Individual grap> | | Average Diamete> | | Average Fruit p> | | | | Average Brix | |
| Part Rated | | | | | FRUIT | | FRUIT | | CLUSTR | | FRUIT | | FRUIT | |
| Rating Type | | | | | WEIGHT | | DIAMET | | COUNT | | PH | | BRIX | |
| Rating Unit/Min/Max | | | | | g | | mm | | number | | PH, 0, 14 | | %, 0, 100 | |
| Number of Subsamples | | | | | 1 | | 1 | | 1 | | 1 | | 1 | |
| Trt | Treatment | | Rate | Appl | | | | | | | | | | |
| No. | Name | Rate | Unit | Code | 6* | | 7* | | 8* | | 9* | | 10* | |
| 1 | Untreated | | | ABCD | 6.498 | — | 23.358 | — | 32.2 | a | 4.0 | — | 21.72 | a |
| | Check | | | | | | | | | | | | | |
| 2 | MDJ Elicitor | 32 | oz/a | ABCD | 7.277 | — | 23.778 | — | 32.5 | a | 4.0 | — | 20.73 | ab |
| 3 | MDJ Elicitor | 48 | oz/a | ABCD | 7.232 | — | 23.917 | — | 34.3 | a | 4.0 | — | 20.17 | b |
| 4 | Regalia ® | 1.5 | qt/100 gal | ABCD | 6.933 | — | 23.288 | — | 24.7 | b | 4.0 | — | 20.38 | ab |
| | Stargus ® | 2 | qt/100 gal | ABCD | | | | | | | | | | |

| | | | | | |
|---|---|---|---|---|---|
| LSD P - .05 | 0.7427 | 0.8169 | 6.28 | — | 1.131 |
| Standard Deviation | 0.6035 | 0.6638 | 5.11 | 0.00 | 0.919 |
| CV | 8.64 | 2.81 | 16.52 | 0.0 | 4.43 |
| Levene's F\hat{ } | 0.341 | 0.206 | 0.101 | — | 0.202 |
| Levene's Prob(F) | 0.796 | 0.891 | 0.958 | — | 0.894 |
| Shapiro-Wilk\hat{ } | 0.9617 | 0.9859 | 0.9857 | — | 0.9695 |
| P(Shapiro-Wilk)\hat{ } | 0.4728 | 0.9759 | 0.9736 | — | 0.654 |
| Skewness\hat{ } | −0.0278 | 0.1321 | 0.1779 | — | −0.4324 |
| P(Skewness)\hat{ } | 0.9563 | 0.7945 | 0.726 | — | 0.3972 |
| Kurtosis\hat{ } | −1.0021 | −0.4022 | 0.3083 | — | −0.3983 |
| P(Kurtosis)\hat{ } | 0.3143 | 0.6835 | 0.7545 | — | 0.6864 |
| Replicate F | 1.077 | 1.557 | 2.468 | 0.000 | 2.062 |
| Replicate Prob(F) | 0.4117 | 0.2316 | 0.0802 | 1.0000 | 0.1275 |
| Treatment F | 2.116 | 1.301 | 4.203 | 0.000 | 3.336 |
| Treatment Prob(F) | 0.1410 | 0.3105 | 0.0241 | 1.0000 | 0.0480 |

TABLE 12
abbreviations for Tables 7-11

Pest Type
D, Disease = Disease, such as a fungus, bacteria, or virus
Pest Code
ASPECA, Aspergillus carbonarius, bunch rot of grapes = US
Crop Type, Code
C = EPPO species (Bayer) codes
VITSS, BGRA, Vitis sp., Grape = US
Part Rated
CLUSTR = cluster
FRUIT = fruit
Rating Type
PESINC = pest incidence
PESSEV = pest severity
WEIGHT = weight
DIAMET = diameter
COUNT = count
PH = pH
BRIX = brix content
Rating Unit/Min/Max
g = gram
mm = millimeter
PH, 0, 14 = ph
%, 0, 100 = percent

### Example 7: Synergistic Control of Pests and Pathogens with MDJ and a Biological

Application of a biological in conjunction with MDJ treatment has been shown to further decrease the prevalence of disease in a plant of the same Clade, Cannabis spp.

A Botrytis cinerea isolate was cultured onto potato-dextrose agar (PDA) and re-isolated by taking a mycelial plug from the edge of actively growing cultures every 2-3 weeks to maintain active growing culture. It was maintained at 20° C. under continuous light (˜58 pEin m⁻² s⁻¹). An inoculum was prepared by flooding a full grown B. cinerea PDA plate with DI water and 0.1% Tween-20 to create a suspension of fungal spores. Spore count was quantified.

In the first inoculation, a suspension of 1.2×10⁴ spores of B. cinerea/mL was created, and 1.5 mL was applied to the top cola/underdeveloped inflorescence of each hemp plant in the first week of flowering. In the second inoculation, a suspension of 1.5×10⁵ spores of B. cinerea/mL was created, and sucrose was added to 1% concentration, and the plants were sprayed until drip using a backpack sprayer.

Inoculated plants were placed in a controlled growth environment with a constant temperature of 20-25° C. and 50-70% relative humidity. (See Zhang et al., “Infection Assays of Tomato and Apple Fruit by the Fungal Pathogen Botrytis cinerea,” bio-protocol 2014; 4 (23): 1-4. See also, Bulger et al. Phytopathology 1987; 77 (8): 1225-1230 and Garfinkel, Plant Disease 2020; 104 (7): 2026.)

Treatments comprising 1 mM or 5 mM jasmonate (MDJ) were applied alone or alongside a biological (Continuum™). These treatment conditions were compared to control (no MDJ, no biological). Each treatment group had 8 replicates. 500 mL of each treatment solution was prepared for application as a foliar spray. Plants within a treatment condition were sprayed with the corresponding treatment until drip with a hand sprayer. Approximately 400 mL of each treatment were applied per application per plant. Treatments were applied to inflorescences. Table 13 provides the labels and descriptions for each of the treatment conditions.

TABLE 13
Treatment Conditions

| Label | Description |
|---|---|
| A | Control, 0.1% tween/span mixture |
| B | 1 mM MDJ |
| C | 5 mM MDJ |
| D | Continuum ™ only (30 mL per gallon) |
| E | 1 mM MDJ + 30 mL/gallon Continuum ™ |
| F | 5 mM MDJ + 30 mL/gallon Continuum ™ |

The treatments were applied in the first week of flowering, followed 24 hours later by an inoculation of Botrytis cinerea, and then the treatments were applied again four weeks later, followed 24 hours later by another inoculation. Table 14 contains the dates of treatment, inoculation, and harvest.

TABLE 14
Treatment, Infection, and Harvest Dates

| Date | Event |
|---|---|
| May 31, 2022 | First Treatment spray (A-F) |
| Jun. 2, 2022 | First Infection |
| Jun. 28, 2022 | Second Treatment Spray (A-F) |
| Jun. 29, 2022 | Second Infection, with 1% sugar solution |
| Jul. 11, 2022 (week of) | Harvest |

Botrytis cinerea disease scoring was based on visual inspection of infection amounts. 0: No part of the plant affected; 1: minimal infection, isolated in 1 or 2 areas; 2: mild infection, multiple infection sites, but somewhat isolated; 3: moderate infection, about half of the plant is infected; 4: severe infection, most of the plant is infected; 5: extreme infection, entire plant is infected, with proliferating mold and/or necrotic symptoms occurring.

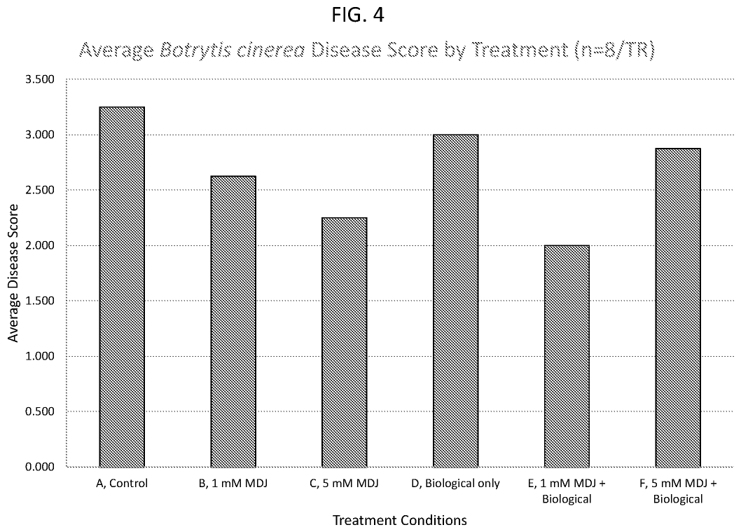

At harvest, the plants in all treatment conditions were evaluated based on their Botrytis disease score (0-5). Table 15 and FIG. 4 show a summary of the average results from each treatment condition. Surprisingly, condition E, with 1 mM MDJ and 30 mL/gallon Continuum™ outperformed all other conditions in terms of reducing disease incidence and/or progression caused by Botrytis cinerea infection. These results suggest a synergistic effect, because the disease score for condition E compared to control is improved more than the sum of the effects of either agent alone (condition B or condition D).

TABLE 15
Average Disease Scores per Treatment Condition

| Treatment | Average Disease Score |
|---|---|
| A, Control | 3.250 |
| B, 1 mM MDJ | 2.625 |
| C, 5 mM MDJ | 2.250 |
| D, Biological only | 3.000 |
| E, 1 mM MDJ + Biological | 2.000 |
| F, 5 mM MDJ + Biological | 2.875 |

### Example 8: Control of Other Grapevine Pests and Pathogens

Additionally, there are a number of pests that affect grapevine that may also be controlled, repelled, or prevented by the compositions and methods disclosed herein. For example, Climbing Cutworms, Grape Berry Moth, Grape Cane Borer, Grape Flea Beetle, Grape Leaffolder, Grape Omnivorous Leafroller, Grape Phylloxera, Grape Root Borer, Grape Rootworm, Grape Tumid Gallmaker, Green June Beetle, Japanese Beetle, Multicolored Asian Lady Beetle, Rose Chafer, Western Grapeleaf Skeletonizer, Leafhoppers, Mealybugs, Mites, and Thrips.

Within the leafhopper category, a number of species are known to cause damage to grapevines, including for example, grape leafhopper (Erythroneura comes), potato leafhopper (Empoasca fabae), Eastern grape leafhopper (Erythroneura comes), glassy-winged sharpshooter (Homalodisca coagulate), three-banded leafhopper (Erythroneura tricincta), Virginia creeper leafhopper (Erythroneura ziczac), Western grape leafhopper (Erythroneura elegantula), and the variegated leafhopper (Erythroneura variabilis) Thresholds for leafhopper vary depending on the generation and species (of insect), type of grape, canopy size, and region.

### NUMBERED EMBODIMENTS

Notwithstanding the appended claims, the disclosure sets forth the following numbered embodiments:
1. A method for altering the production of one or more metabolites in a Vitis spp. plant, plant part, or plant cell comprising: applying an effective amount of at least one elicitor, wherein the at least one elicitor is a jasmonate selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.
2. The method of embodiment 1, wherein the method comprises applying an effective amount of two jasmonates.
3. The method of embodiment 1, wherein the method comprises applying an effective amount of three jasmonates.
4. The method of embodiment 1, wherein the jasmonate is methyl jasmonate.
5. The method of embodiment 1, wherein the jasmonate is methyl dihydrojasmonate.
6. The method of embodiment 1, wherein the jasmonate is cis-jasmone.
7. The method of embodiment 2, wherein the two jasmonates are methyl jasmonate and methyl dihydrojasmonate.
8. The method of embodiment 2, wherein the two jasmonates are methyl jasmonate and cis-jasmone.
9. The method of embodiment 2, wherein the two jasmonates are methyl dihydrojasmonate and cis-jasmone.
10. The method of embodiment 3, wherein the three jasmonates are methyl jasmonate, methyl dihydrojasmonate, and cis-jasmone.
11. The method of any one of embodiments 1-10, wherein the method further comprises applying an effective amount of a non-jasmonate elicitor and/or a plant growth regulator.
12. The method of embodiment 11, wherein the non-jasmonate elicitor is a salicylate.
13. The method of embodiment 12, wherein the salicylate is methyl salicylate and/or salicylic acid.
14. The method of embodiment 11, wherein the plant growth regulator is an ethylene inhibitor.
15. The method of embodiment 14, wherein the ethylene inhibitor is 1-methylcyclopropene.
16. The method of any one of embodiments 1-15, wherein the elicitor is applied as a foliar spray or root drench.
17. The method of any one of embodiments 1-16, wherein the elicitor is applied prior to veraison.
18. The method of any one of embodiments 1-16, wherein the elicitor is applied at veraison.
19. The method of any one of embodiments 1-16, wherein the elicitor is applied at 15% veraison.
20. The method of any one of embodiments 1-16, wherein the elicitor is applied at 25% veraison.
21. The method of any one of embodiments 1-16, wherein the elicitor is applied at 50% veraison.
22. The method of any one of embodiments 1-16, wherein the elicitor is applied at 75% veraison.
23. The method of any one of embodiments 1-22, wherein the step of applying the elicitor is repeated one or more times, thereby carrying out a plurality of applications.
24. The method of embodiment 23, wherein each application is separated by between 5-20 day.
25 The method of embodiments 23, wherein at least two applications are separated by at least 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days.
26 The method of embodiment 23, wherein at least two applications are separated by between 5-20 days.
27. The method of any one of embodiments 1-16, wherein the elicitor is applied about 24-72 hours prior to harvest.
28. The method of any one of embodiments 1-27, wherein the effective amount of the jasmonate is between 10 mL to 1 L of a composition comprising between 1 mM and 10 mM of the jasmonate.
29 The method of embodiment 28, wherein the composition comprises between 2.5 mM and 5 mM of the jasmonate.
30. The method of any one of embodiments 1-27, wherein the effective amount is between 350-850 ppm with an application rate of 50 gallons per acre.
31. The method of any one of embodiments 1-27, wherein the effective amount is between 850-1700 ppm with an application rate of 100 gallons per acre.
32. The method of any one of embodiments 1-31, wherein the metabolite is a sugar, simple phenolic, flavonoid, alkaloid, stilbenoid, tannin, or terpene.
33. The method of embodiment 32, wherein the flavonoid is an anthocyanin.
34. The method of embodiment 32, wherein the stilbenoid is resveratrol or viniferin.
35. A method of altering metabolite levels in a Vitis spp. plant or plant part, said method comprising: applying an effective amount of methyl dihydrojasmonate to a Vitis spp. plant or plant part.
36. The method of embodiment 36, wherein the metabolite is increased compared to an untreated Vitis spp. plant or plant part.
37. The method of embodiment 36, wherein the metabolite is decreased compared to an untreated Vitis spp. plant or plant part.
38. The method of any one of embodiments 35-37, wherein the effective amount of methyl dihydrojasmonate is a composition having between 1 mM and 10 mM methyl dihydrojasmonate applied at a rate of 50-100 gallons per acre.
39. The method of embodiment 38, wherein the composition comprises about 2.5 mM methyl dihydrojasmonate.
40. The method of embodiment 38, wherein the composition comprises about 4.25 mM methyl dihydrojasmonate.
41. The method of embodiment 38, wherein the composition comprises about 7.5 mM methyl dihydrojasmonate.
42. The method of any one of embodiments 38-41, wherein the composition comprises an adjuvant.
43. The method of embodiment 42, wherein the adjuvant is a surfactant.
44. The method of embodiment 43, wherein the surfactant is polysorbate-20.
45. The method of any one of embodiments 38-44, wherein the composition comprises at least one of an additional elicitor, fungicide, pesticide, and plant beneficial nutrient.
46. The method of embodiment 45, wherein the additional elicitor an ethylene inhibitor.
47. The method of embodiment 46, wherein the ethylene inhibitor is 1-methylcyclopropene.
48. The method of any one of embodiments 38-47, wherein the composition is applied two or more times, thereby carrying out a plurality of composition applications.
49. The method of embodiment 48, wherein each composition application is separated by at least 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days.
50. The method of embodiment 48, wherein each composition application is separated by between 5-20 days.
51. The method of embodiment 48, wherein at least two composition applications are separated by about 14 days.
52. The method of any one of embodiments 35-51, wherein a salicylate is also applied to the Vitis spp. plant or plant part.
53. The method of embodiment 52, wherein the salicylate is methyl salicylate and/or salicylic acid.
54. The method of embodiment 53, wherein the salicylate is applied at a concentration of between 1 mM and 10 mM.
55. The method of any one of embodiments 52-54, wherein the salicylate is applied simultaneously with the effective amount of methyl dihydrojasmonate.
56. The method of any one of embodiments 35-55, wherein the effective amount of methyl dihydrojasmonate is applied as a foliar spray or root drench.
57. The method of any one of embodiments 35-56, wherein the method reduces the content variability of a metabolite in a population of Vitis spp. plants.
58. A method for increasing the flavonoid content in a Vitis spp. plant, plant part, or plant cell, the method comprising: applying an effective amount of methyl dihydrojasmonate, wherein said effective amount is comprised of a composition having between 1 mM and 10 mM methyl dihydrojasmonate applied at an application rate of between 50-100 gallons per acre.
59. The method of embodiment 58, wherein the flavonoid is an anthocyanin.
60. The method of embodiment 59, wherein the method increases total anthocyanins.
61. The method of embodiment 58, wherein the flavonoid is a flavonol.
62. The method of embodiment 58, wherein the flavonoid is a flavan-3-ol monomer or proanthocyanidin.
63. The method of embodiment 62, wherein the flavan-3-ol is at least one of quercetin-3-glucoside, myricetin, catechin, epicatechin, epigallocatechin, procyanidin B1, procyanidin B2 and epicatechin 3-gallate.
64. A method for increasing the stilbene content in a Vitis spp. plant, plant part, or plant cell, the method comprising: applying an effective amount of methyl dihydrojasmonate, wherein said effective amount is comprised of a composition having between 1 mM and 10 mM methyl dihydrojasmonate applied at an application rate of between 50-100 gallons per acre.
65. The method of embodiment 64, wherein the stilbene is selected from the group consisting of trans-resveratrol (3,5,4′-trihydroxystilbene), cis-piceid, trans-piceid (resveratrol glucosides), and piceatannol (3,4,3′,5′-tetrahydroxy-trans-stilbene).
66. A composition comprising methyl dihydrojasmonate and a plant cell from a Vitis spp. plant.
67. A method for increasing total anthocyanins in a Vitis spp. fruit comprising: applying a composition comprising between 1 mM and 10 mM methyl dihydrojasmonate to a Vitis spp. plant, plant part, or plant cell, wherein the application of the composition increases total anthocyanins in Vitis spp. fruit compared to untreated controls.
68. The method of embodiment 67, wherein the method increases total anthocyanins by at least 8%.
69. The method of embodiment 67, wherein the method increases total anthocyanins by at least 12%.
70. The method of embodiment 67, wherein the method increases total anthocyanins by at least 16%.
71. The method of any one of embodiments 67-70, wherein the method reduces the content variability of total anthocyanins in a population of Vitis spp. plants.
72. The method of any one of embodiments 67-71, wherein the Vitis spp. plant, plant part, or plant cell is V. vinifera, V. labrusca, V. rotundifolia V. amurensis, and hybrids thereof.
73. A method for increasing Brix in a Vitis vinifera fruit, comprising: applying a composition comprising between 1 mM and 10 mM methyl dihydrojasmonate to a Vitis vinifera plant, plant part, or plant cell, wherein the application of the composition increases Brix in Vitis vinifera fruit compared to untreated controls.
74. The method of embodiment 73, wherein the Vitis vinifera plant, plant part, or plant cell is a wine variety.
75. The method of embodiment 73 or 74, wherein Vitis vinifera plant, plant part, or plant cell is a wine variety selected from Cabernet Sauvignon, Pinot Noir, Merlot, Syrah, Grenache, Sangiovese, Nebbiolo, Tempranillo, and Malbec.
76. The method of any one of embodiments 73-75, wherein the method increases Brix by at least 25%.
77. The method of any one of embodiments 73-75, wherein the method increases Brix by at least 50%.
78. The method of any one of embodiments 73-75, wherein the method increases Brix by at least 75%.
79. The method of any one of embodiments 73-78, wherein the method reduces the content variability of Brix in a population of Vitis vinifera plants.
80. A method for treating or preventing a Vitis spp. pest or plant pathogen, the method comprising: applying a composition having between 1 mM and 10 mM methyl dihydrojasmonate to a plant, plant part, or plant cell, wherein application of the composition reduces the percent severity and/or percent incidence of a pest or pathogen compared to untreated plants.
81. The method of embodiment 80, wherein the plant pathogen is Botrytis cinerea.
82. The method of embodiment 80, wherein the plant pathogen is Aspergillus carbonarius.
83. The method of embodiment 80, wherein the plant pathogen is Erysiphe necator.
84. The method of any one of embodiments 80-83, wherein the method reduces the percent severity by at least 25%.
85. The method of any one of embodiments 80-83, wherein the method reduces the percent severity by at least 40%.
86. The method of any one of embodiments 80-85, wherein the method reduces the percent incidence by at least 15%.
87. The method of any one of embodiments 80-85, wherein the method reduces the percent incidence by at least 20%.
88. The method of any one of embodiments 80-85, wherein the method reduces the percent incidence by at least 25%.
89. The method of any one of embodiments 80-88, wherein the method reduces the number of infected leaves, percent of infected leaves, number of infected fruits, percent of infected fruits, number of dead leaves, percent of dead leaves, number of damaged leaves, percent of damaged leaves, number of damaged fruits, percent of damaged fruits, degree of infection, progression of infection, degree of infestation, and/or progression of infestation compared to untreated plants.
90. The method of any one of embodiments 67-89, wherein the composition comprises about 2.5 mM methyl dihydrojasmonate.
91. The method of any one of embodiments 67-89, wherein the composition comprises about 4.25 mM methyl dihydrojasmonate.
92. The method of any one of embodiments 67-89, wherein the composition comprises about 7.5 mM methyl dihydrojasmonate.
93 The method of any one of embodiments 67-92, wherein the composition comprises an adjuvant.
94. The method of any one of embodiments 67-93, wherein the composition comprises a surfactant.
95. The method of any one of embodiments 67-94, wherein the composition comprises at least one of an additional elicitor, fungicide, pesticide, and plant beneficial nutrient.
96. The method of any one of embodiments 67-95, wherein the method further comprises applying an effective amount of a non-jasmonate elicitor and/or a plant growth regulator.
97. The method of any one of embodiments 67-96, wherein the method further comprises applying an ethylene inhibitor.
98. The method of any one of embodiments 67-97, wherein the method further comprises applying a biological, wherein the biological is applied separately or incorporated into the composition comprising methyl dihydrojasmonate.
99. The method of embodiment 98, wherein the biological comprises species of bacteria from the genera of Azospirillum, Bacillus, Paenibacillus, and/or Pantoea.
100. The method of embodiment 98 or 99, wherein the biological comprises species of Azospirillum brasilense, Bacillus amyloliquefaciens, Bacillus laterosporus, Bacillus licheniformis, Bacillus pumilus, Bacillus subtilis, Bacillus thuringiensis, Paenibacillus chitinolyticus, and/or Pantoea dispersa.
101. The method of any one of embodiments 98-100, wherein the biological comprises Azospirillum brasilense strain Pbio1, Azospirillum brasilense strain Pbul1, Azospirillum brasilense strain Pnem1, Azospirillum brasilense strain Pstr1, Bacillus amyloliquefaciens strain Icon4, Bacillus amyloliquefaciens strain Itri3, Bacillus amyloliquefaciens strain Pbot1, Bacillus pumilus strain Icon3, Bacillus pumilus strain Itri2, Bacillus spp. strain Pnem2, Bacillus subtilis strain Icon2, Bacillus subtilis strain Itri1, Bacillus thuringiensis var. kurstaki strain Pbel1, Bacillus thuringiensis var. kurstaki strain Pbel1F, Bacillus thuringiensis var. kurstaki strain Pbel1S, Bacillus thuringiensis var. kurstaki strain Pbel116SC, Bacillus thuringiensis var. kurstaki strain Plep1, Paenibacillus chitinolyticus strain Icon1, Pantoea dispersa strain Pbio2, and/or Pantoea dispersa strain Pbul2.
102. The method of any one of embodiments 98-101, wherein the biological comprises about 10⁵ to 10⁹ CFU/mL or CFU/g of a plant-beneficial microbe.
103. The method of any one of embodiments 98-102, wherein the biological is applied one or more additional times during the life cycle of the plant.
104. The method of any one of embodiments 98-103, wherein the biological is a composition comprising Bacillus subtillis, Bacillus pumilus, and Bacillus amyloliquefaciens.
105. The method of any one of embodiments 98-104, wherein the biological is a liquid composition comprising Bacillus subtillis at a concentration of about 1-10×10⁹ CFU/ml, Bacillus pumilus at a concentration of about 1-10×10⁹ CFU/ml, and Bacillus amyloliquefaciens at a concentration of about 0.5-5×10⁹ CFU/ml.
106. The method of any one of embodiments 98-105, wherein the biological is a liquid composition comprising Bacillus subtillis at a concentration of about 4×10⁹ CFU/ml, Bacillus pumilus at a concentration of about 4×10⁹ CFU/ml, and Bacillus amyloliquefaciens at a concentration of about 2×10⁹ CFU/ml.
107. The method of any one of embodiments 67-106, wherein the composition is applied at an application rate of about:
   (a) 5-6 ounces per plant;
   (b) 4-5 ounces per plant;
   (c) 3-4 ounces per plant;
   (d) 2-3 ounces per plant;
   (e) 1-2 ounces per plant;
   (f) 0.1-1 ounce per plant; or
   (g) 150-500 mL per plant.
108. The method of any one of embodiments 98-107, wherein the biological is a composition comprising Paenibacillus chitinolyticus, Bacillus subtilis, Bacillus pumilus, and Bacillus amyloliquefaciens.
109. The method of any one of embodiments 98-108, wherein the biological is a composition comprising about 10⁵-10⁷ CFU/mL Paenibacillus chitinolyticus, about 10⁵-10⁷ CFU/mL Bacillus subtilis, about 10⁵-10⁷ CFU/mL Bacillus pumilus, and about 10⁵-10⁷ CFU/mL Bacillus amyloliquefaciens.
110. The method of any one of embodiments 98-109, wherein the biological is a composition comprising about 10⁶ CFU/mL Paenibacillus chitinolyticus, about 10⁶ CFU/mL Bacillus subtilis, about 10⁶ CFU/mL Bacillus pumilus, and about 10⁶ CFU/mL Bacillus amyloliquefaciens.
111. The method of any one of embodiments 98-110, wherein the biological is applied at an application rate of about:
   (a) 0.1-5 L/acre; or about
   (b) 0.1-10 mL per plant.
112. The method of any one of embodiments 98-111, wherein the biological is applied at an application rate of about:
   (a) 0.1-1 L/acre;
   (b) 1-2 L/acre;
   (c) 2-3 L/acre;
   (d) 3-4 L/acre;
   (e) 4-5 L/acre;
   (f) 0.1-1 mL per plant;
   (g) 1-2 mL per plant;
   (h) 2-3 mL per plant;
   (i) 3-4 mL per plant; or
   (j) 4-5 mL per plant.
113. The method of any one of embodiments 98-112, wherein the biological is applied about twice a week, once a week, once every two weeks, once every three weeks, or once a month.
114. The method of any one of embodiments 98-113, wherein the biological is a composition comprising Bacillus thuringinesis, Azospirillum brasilense, Pantoea dispersa, and/or Bacillus amyloliquefaciens.
115. The method of any one of embodiments 98-114, wherein the biological is a composition comprising about 10-50×10⁶ IU/g Bacillus thuringinesis, about 100-1000 g/L Azospirillum brasilense, about 10⁶-10⁹ CFU/mL or about 10⁸-10¹⁰ CFU/g Azospirillum brasilense, about 10⁶-10⁹ CFU/mL or about 10⁸-10¹⁰ CFU/g Pantoea dispersa, and/or about 10⁶-10⁹ CFU/mL Bacillus amyloliquefaciens.
116. The method of any one of embodiments 98-115, wherein the biological is a composition comprising Bacillus amyloliquefaciens.
117. The method of any one of embodiments 98-116, wherein the biological is a composition comprising about 10⁶-10⁹ CFU/mL Bacillus amyloliquefaciens.
118. The method of any one of embodiments 98-117, wherein the biological is a composition comprising about 10⁸ CFU/mL Bacillus amyloliquefaciens.
119. The method of any one of embodiments 98-118, wherein the biological is applied as a foliar spray at a dose of about 12-15 cc/L about every 7-14 days.
120. The method of any one of embodiments 98-119, wherein the biological is applied as a drip irrigation at a rate of about 5-15 L/ha about every 30 days.
121. The method of any one of embodiments 98-120, wherein the biological is applied as a drip irrigation at a rate of about 5 L/ha about 5-7 days after transplanting, about 10 L/ha about 30-40 days after first application, and about 15 L/ha about 50-60 days after first application.
122. The method of any one of embodiments 67-121, wherein the composition is applied as a foliar spray.
123. The method of any one of embodiments 67-122, wherein the composition is applied prior to veraison.
124. The method of any one of embodiments 67-123, wherein the composition is applied at veraison.
125. The method of any one of embodiments 67-124, wherein the composition is applied at 15% veraison.
126. The method of any one of embodiments 67-125, wherein the composition is applied at 25% veraison.
127. The method of any one of embodiments 67-126, wherein the composition is applied at 50% veraison.
128. The method of any one of embodiments 67-127, wherein the composition is applied at 75% veraison.
129. The method of any one of embodiments 67-128, wherein the step of applying the composition is repeated one or more times, thereby carrying out a plurality of applications.
130. The method of any one of embodiments 67-129, wherein the composition is applied about 24-72 hours prior to harvest.
131. The method of any one of embodiments 67-130, wherein the composition comprising methyl dihydrojasmonate is applied at a rate of 50-500 gallons per acre.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world. International Application no. PCT/US2022/081326 is herein incorporated by reference in its entirety. International Publication no. WO2022/026613 is herein incorporated by reference in its entirety.

1. A method for increasing total anthocyanins in a Vitis spp. fruit comprising: applying a composition comprising between 1 mM and 10 mM methyl dihydrojasmonate to a Vitis spp. plant, plant part, or plant cell, wherein the application of the composition increases total anthocyanins in Vitis spp. fruit compared to untreated controls.

2. The method of claim 1, wherein the method increases total anthocyanins by at least 8%.

3. The method of claim 1, wherein the method increases total anthocyanins by at least 12%.

4. The method of claim 1, wherein the method increases total anthocyanins by at least 16%.

5. The method of claim 1, wherein the method reduces the content variability of total anthocyanins in a population of Vitis spp. plants.

6. The method of claim 1, wherein the Vitis spp. plant, plant part, or plant cell is V. vinifera, V. labrusca, V. rotundifolia V. amurensis, and hybrids thereof.

7. The method of claim 1, wherein the application of the composition increases Brix in Vitis vinifera fruit compared to untreated controls.

8. The method of claim 7, wherein the Vitis vinifera plant, plant part, or plant cell is a wine variety selected from Cabernet Sauvignon, Pinot Noir, Merlot, Syrah, Grenache, Sangiovese, Nebbiolo, Tempranillo, and Malbec.

9. (canceled)

10. The method of claim 7, wherein the method increases Brix by at least 25%.

11. The method of claim 7, wherein the method increases Brix by at least 50%.

12. The method of claim 7, wherein the method increases Brix by at least 75%.

13. The method of claim 7, wherein the method reduces the content variability of Brix in a population of Vitis vinifera plants.

14.-26. (canceled)

27. The method of claim 1, wherein the composition comprises an adjuvant.

28. The method of claim 1, wherein the composition comprises a surfactant.

29. The method of claim 1, wherein the composition comprises at least one of an additional elicitor, fungicide, pesticide, and plant beneficial nutrient.

30. (canceled)

31. The method of claim 1, wherein the method further comprises applying an ethylene inhibitor.

32. The method of claim 1, wherein the method further comprises applying a biological.

33. The method of claim 1, wherein the composition comprises species of bacteria from the genera of Azospirillum, Bacillus, Paenibacillus, and/or Pantoea.

34. The method of claim 1, wherein the composition comprises at least one of Azospirillum brasilense, Bacillus amyloliquefaciens, Bacillus laterosporus, Bacillus licheniformis, Bacillus pumilus, Bacillus subtilis, Bacillus thuringiensis, Paenibacillus chitinolyticus, and Pantoea dispersa.

35. The method of claim 1, wherein the composition comprises Bacillus subtillis at a concentration of about 1-10×10⁹ CFU/ml, Bacillus pumilus at a concentration of about 1-10×10⁹ CFU/ml, and Bacillus amyloliquefaciens at a concentration of about 0.5-5×10⁹ CFU/ml.

36. The method of claim 1, wherein the composition comprises about 10⁵-10⁷ CFU/mL Paenibacillus chitinolyticus, about 10⁵-10⁷ CFU/mL Bacillus subtilis, about 10⁵-10⁷ CFU/mL Bacillus pumilus, and about 10⁵-10⁷ CFU/mL Bacillus amyloliquefaciens.

37. The method of claim 1, wherein the composition comprises about 10-50×10⁶ IU/g Bacillus thuringinesis, about 100-1000 g/L Azospirillum brasilense, about 10⁶-10⁹ CFU/mL or about 10⁸-10¹⁰ CFU/g Azospirillum brasilense, about 10⁶-10⁹ CFU/mL or about 10⁸-10¹⁰ CFU/g Pantoea dispersa, and/or about 10⁶-10⁹ CFU/mL Bacillus amyloliquefaciens

38. The method of claim 1, wherein the composition is applied as a foliar spray.

39. The method of claim 1, wherein the composition is applied prior to or at veraison.

40. (canceled)

41. The method of claim 1, wherein the composition is applied at 15% veraison, 25% veraison, 50% veraison, or 75% veraison.

42. (canceled)

43. (canceled)

44. (canceled)

45. The method of claim 1, wherein the step of applying the composition is repeated one or more times, thereby carrying out a plurality of applications.

46. The method of claim 1, wherein the composition is applied about 24-72 hours prior to harvest.

47. The method of claim 1, wherein the composition comprising methyl dihydrojasmonate is applied at a rate of 50-500 gallons per acre.
